(19) United States
(12) Patent Application Publication
(10) Pub. No.: US 2025/0060592 A1
(43) Pub. Date: Feb. 20, 2025

(54) DETECTION LENS AND DETECTION METHOD FOR HEAD-MOUNTED DISPLAY

(71) Applicant: Goertek Optical Technology Co., Ltd., Weifang, Shandong (CN)

(72) Inventor: SHIYU Zhang, Shandong (CN)

(73) Assignee: Goertek Optical Technology Co., Ltd., Weifang, Shandong (CN)

(21) Appl. No.: 18/725,953

(22) PCT Filed: Dec. 31, 2021
(86) PCT No.: PCT/CN2021/143902

§ 371 Date: Jul. 1, 2024

(51) Int. Cl. G02B 27/01; G01M 11/02; G02B 27/00; G02B 27/09

(52) U.S. Cl. CPC G02B 27/0172; G01M 11/0257; G02B 27/0025; G02B 27/0955; G02B 2027/0138

(57) ABSTRACT

The present disclosure discloses a detection lens and detection method for a head-mounted display. The detection lens has a light incident end and is configured to receive light from the light incident end. The detection lens comprises a lens group, an overall entrance pupil of the lens group overlaps with its own aperture stop. The lens group comprises a first lens group and a second lens group, the first lens group is close to the light incident end relative to the second lens group in an axial direction of the detection lens, an effective focal length of the first lens group ranges from 15 mm to 40 mm, a magnification of the second lens group ranges from 0.5 to 2, and an effective focal length of the second lens group ranges from 40 mm to 500 mm.

### CROSS-REFERENCE TO RELATED APPLICATIONS

The present disclosure is a National Stage of International Application No. PCT/CN2021/143902, filed on Dec. 31, 2021, which is hereby incorporated by reference in its entirety.

### TECHNICAL FIELD

The present invention relates to the field of optics, and specifically to a detection lens and a detection method for a head-mounted display.

### BACKGROUND

In recent years, consumer electronics products are becoming popular in the market. Among them, virtual reality devices (VR) and augmented reality devices (AR), because of their special display effects, are capable of immersing users into special audio-visual effects, and therefore are widely favored by consumers. In practical applications, since VR and AR devices perform displaying at positions very close to the human eye, their imaging effects differ from those of traditional TVs and displays. Accordingly, detection of the display effects of VR and AR devices require special lenses.

Existing detection display lenses are often unable to meet demands of the detection function of such close-range displays, as such form of detection needs to simulate the close-range visualization of the human eye.

Therefore, it is necessary to improve the lenses used for detection.

### SUMMARY

An objective of embodiments of the present disclosure is to provide a new technical solution for detecting the display effect of a head-mounted display.

To achieve the objective of the present disclosure, the present disclosure provides the following technical solutions:
According to one aspect of the present disclosure, a detection lens for a head-mounted display is provided, the detection lens has a light incident end and is configured to receive light from the light incident end;
the detection lens comprises a lens group, and an overall entrance pupil of the lens group overlaps with its own aperture stop; and
the lens group comprises a first lens group and a second lens group, the first lens group is close to the light incident end relative to the second lens group in an axial direction of the detection lens, an effective focal length of the first lens group ranges from 15 mm to 40 mm, a magnification of the second lens group ranges from 0.5 to 2, and an effective focal length of the second lens group ranges from 40 mm to 500 mm.

Optionally, an aperture stop of the detection lens is less than or equal to 5 mm.

Optionally, both the first lens group and the second lens group have a diameter of less than or equal to 65 mm.

Optionally, the first lens group comprises at least one condenser lens with a positive optical power; and

the second lens group comprises a double-Gauss lens group.

Optionally, the detection lens has a field-of-view angle ranging from 55 degrees to 125 degrees.

Optionally, the field-of-view angle of the detection lens ranges from 55 degrees to 70 degrees, the first lens group comprising one or two condenser lenses, wherein in the axial direction of the detection lens, each of the condenser lenses is located close to the light incident end in the first lens group.

Optionally, the first lens group comprises two condenser lenses which are respectively a first condenser lens and a second condenser lens, with the first condenser lens being close to the light incident end relative to the second condenser lens;
a radius of curvature of the light incident surface of the first condenser lens ranges from −14.5 mm to −16.5 mm, a radius of curvature of the light emergent surface of the first condenser lens ranges from −12.5 mm to −14.5 mm, and a thickness of the first condenser lens ranges from 2.7 mm to 3.9 mm; and
a radius of curvature of the light incident surface of the second condenser lens ranges from −55.0 mm to −64.0 mm, a radius of curvature of the light emergent surface of the second condenser lens ranges from −27.0 mm to −33.5 mm, and a thickness of the second condenser lens ranges from 4.5 mm to 6.5 mm.

Optionally, the field-of-view angle of the detection lens ranges from 70 degrees to 125 degrees, the first lens group comprising two or three condenser lenses, wherein in the axial direction of the detection lens, each of the condenser lenses is located close to the light incident end in the first lens group.

Optionally, the first lens group comprises two condenser lenses which are respectively a first condenser lens and a second condenser lens, with the first condenser lens being close to the light incident end relative to the second condenser lens;
a radius of curvature of the light incident surface of the first condenser lens ranges from −9.2 mm to −12.0 mm, a radius of curvature of the light emergent surface of the first condenser lens ranges from −10.4 mm to −12.1 mm, and a thickness of the first condenser lens ranges from 6.5 mm to 8.4 mm;
a radius of curvature of the light incident surface of the second condenser lens ranges from −140.0 mm to −152.0 mm, a radius of curvature of the light emergent surface of the second condenser lens ranges from −27.0 mm to −33.5 mm, and a thickness of the second condenser lens ranges from 4.2 mm to 5.1 mm; and
the field-of-view angle of the detection lens ranges from 70 degrees to 95 degrees.

The present disclosure further provides a detection method for a head-mounted display, comprising:
using the detection lens as described above;
aligning a light incident end of the detection lens with a head-mounted display to be detected, so that the axis of the lens overlaps with the optical axis of the device to be detected;
adjusting the light incident end of the detection lens in its axial direction to overlap with the exit pupil projected by the head-mounted display to be detected; and
acquiring the image projected by the head-mounted display to be detected using the detection lens.

One technical effect of this embodiment of the present disclosure is that the lens simulates the close-range visualization of the human eye, and may detect the head-mounted display performing close-range displaying. By configuration of the lens group, the lens can acquire image light within a predetermined range of field-of-view angles so as to implement detection.

### BRIEF DESCRIPTION OF THE DRAWINGS

In order to clearly illustrate embodiments of the present disclosure or technical solutions in the prior art, accompanying drawings that need to be used in description of the embodiments or the prior art will be briefly introduced as follows. Obviously, drawings in following description are only the embodiments of the present disclosure. For those skilled in the art, other drawings can also be obtained according to the disclosed drawings without creative efforts.

FIG. 1 is a schematic diagram of a lens group of an embodiment of a small field of view provided in this solution;

FIG. 2(a) to FIG. 2(c) are schematic diagrams of imaging parameters of a detection lens in the embodiment shown in FIG. 1;

FIG. 3 is a schematic diagram of a lens group in another embodiment of a small field of view provided in this solution;

FIG. 4(a) to FIG. 4(c) are schematic diagrams of imaging parameters of the detection lens in the embodiment described in FIG. 3;

FIG. 5 is a schematic diagram of a lens group for an embodiment of a large field of view provided in this solution;

FIG. 6(a) to FIG. 6(c) are schematic diagrams of imaging parameters of the detection lens for the embodiment shown in FIG. 5;

FIG. 7 is a schematic diagram of a lens group for another embodiment of a large field of view provided in this solution;

FIG. 8(a) to FIG. 8(c) are schematic diagrams of imaging parameters of the detection lens for the embodiment shown in FIG. 7;

FIG. 9 is a schematic diagram of a lens group for an embodiment of a special large field of view provided in this solution;

FIG. 10(a) to FIG. 10(c) are schematic diagrams of imaging parameters of the detection lens for the embodiment shown in FIG. 9;

FIG. 11 is a schematic diagram of a lens group for another embodiment of a special large field of view provided in this solution;

FIG. 12(a) to FIG. 12(c) are schematic diagrams of imaging parameters of the detection lens for the embodiment shown in FIG. 11;

FIG. 13 is a schematic diagram of a lens group for another embodiment of a small field of view provided in this solution.

### DETAILED DESCRIPTION

The technical solutions in the embodiments of the present disclosure will be clearly and completely described below with reference to the drawings in the embodiments of the present disclosure. Apparently, the described embodiments are merely some rather than all of the embodiments of the present disclosure. All other embodiments, acquired by those of ordinary skill in the art based on the embodiments of the present disclosure without any creative work, shall fall into the protection scope of the present disclosure.

The present disclosure provides a detection lens for a head-mounted display. The lens comprises a lens group, which comprises a first lens group and a second lens group.

The detection lens is provided with a light incident end. In a practical application, the light incident end of the detection lens faces toward the display device to be detected, and light enters into the detection lens from the light incident end. An overall entrance pupil of the lens group overlaps with its own aperture stop. In a practical application, the position of the image projected by the display to be detected corresponds to the position of the light incident end of the detection lens, and the light of the image emitted by the display to be detected enters into the detection lens from the light incident end. The detection lens provided by the technical solution is capable of simulating the close-range visual characteristics of the human eye, and the light emergent aperture of the display to be detected overlaps with the light incident end of the detection lens along the optical axis direction. This design conforms to the viewing characteristics of the human eye.

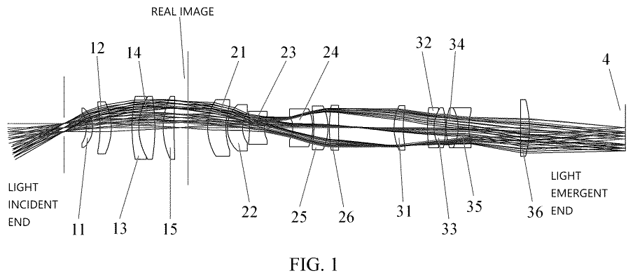

The overall entrance pupil of the lens group overlaps with its own aperture stop. This optical system form conforms to the optical form of the human eye and may better simulate the observation of the human eye. The lens group comprises a first lens group and a second lens group. As shown in FIG. 1, the light incident end of the detection lens is used to receive light. The light is emitted from one side of the light emergent end, and an optical sensor may be provided at the light emergent end for receiving the image. Along the direction from the light incident end to the light emergent end, the first lens group and the second lens group are arranged in sequence. That is, the first lens group is located on a side of the second lens group close to the light incident end.

The first lens group is mainly used to acquire and gather the light emitted by the head-mounted display.

Optionally, the first lens group comprises at least one condenser lens, e.g., comprising one or two condenser lenses. The condenser lens has a positive focal power and may converge the light incident from the incident end into a certain range. As shown in FIG. 1, the focal power of the condenser lens is positive, and the scattered light on one side of the incident end may be processed by the condenser lens before converging into the detection lens and propagating toward the light emergent end. The light converged into the detection lens may be optically processed by subsequent lenses, thereby realizing imaging on the optical sensor.

Optionally, the condenser lens is preferably a crescent-shaped lens. When the condenser lens has a positive focal power, it is further formed into the crescent-shaped lens. This design can further improve the light-gathering effect of the condenser lens, so that the light within the predetermined angle of view is converged into the detection lens by the condenser lens as much as possible. The edge of the crescent-shaped lens is bent and extended relative to the center, making it easier to acquire and converge light at a large angle. In addition, since the crescent-shaped lens with the positive focal power is relatively thin at the edge and the curvature radius of the light incident surface and the light emergent surface are relatively close, the chromatic aberration of the lens is relatively small, and the aberration generated after the light passes through the lens is relatively small. This design reduces the difficulty of aberration correction for the subsequent lens group.

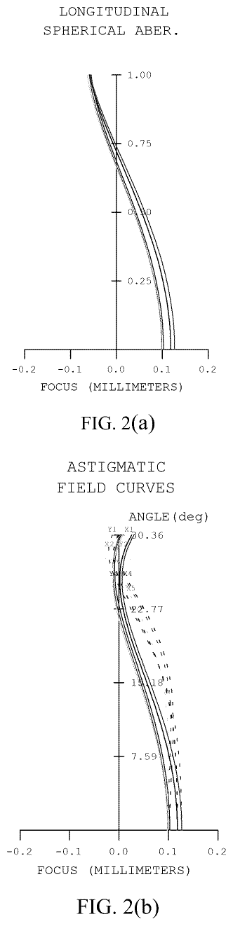

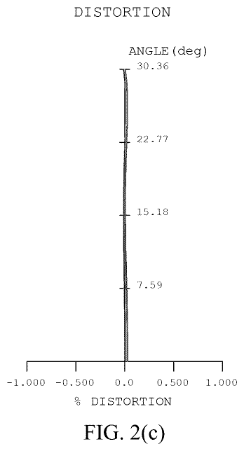

The second lens group is used to perform optical processing on the light incident on the detection lens to correct the aberration of the image projected by the display device. As shown in FIGS. 1 and 2, the second lens group processes aberrations such as spherical aberration and astigmatism with a plurality of lenses.

Optionally, the second lens group may comprise a double-Gauss lens group and a collimating lens group, and the double-Gauss lens group and the collimating lens group comprehensively regulate the above aberration. The double-Gauss lens may be mainly used to regulate the aberrations caused by the asymmetry of the optical system, and the collimating lens is used to correct the light to tend to be parallel light.

In this technical solution, as shown in FIG. 1, the double-Gauss lens group is located close to the light incident end along the direction from the light incident end to the light emergent end. That is, the double-Gauss lens group is closer to the light incident end relative to the collimating lens group.

Optionally, the double-Gauss lens group includes at least three Gauss lenses with positive optical power, which are located close to the light incident end within the double-Gauss lens group. The aforementioned three Gauss lenses can be the first Gauss lens, the second Gauss lens, and the third Gauss lens. The three Gauss lenses are used to converge the light rays projected by the first lens group towards the center of the optical axis.

Optionally, the overall effective focal length range of the first lens group can be selected to be from 15 mm to 40 mm, and the effective focal length range of the second lens group can be selected to be from 40 mm to 500 mm.

The overall effective focal length matching of the first lens group and the second lens group enables the field of view angle of the detection lens to be a value within a range less than or equal to 125 degrees, such as a 60-degree field of view angle or a 90-degree field of view angle. This design approach allows the detection field of the detection lens to basically meet the maximum display angle range of existing head-mounted displays, making it suitable for photographing head-mounted displays with various display effects. It can detect the display image of the head-mounted display at close range.

Optionally, the magnification range of the second lens group can be controlled to be between 0.5 and 2 times. The second lens group, through this magnification range, can provide a certain degree of image zoom while reducing image aberrations, achieving an appropriate detection effect.

This solution effectively simulates the optical state when the human eye actually observes the head-mounted display lens, by firstly designing the entrance pupil of the lens group to overlap with the aperture stop. When actually testing, the position of the image projected by the head-mounted display may be adjusted to a position that overlaps with the light incident end. In order to enable the human eye to view the image when it is being displayed, the head-mounted display projects the image at a predetermined location through an internal lens. By overlapping this position with the light incident, it is possible to desirably simulate the observation state of the human eye. When using the detection lens provided by this solution for testing, it is possible to bring the light incident end of the detection lens close to the head-mounted display and in a position that overlaps with the projected image. In this way, the state of the detection lens when capturing images may be consistent with the state of the human eye observing the image.

Further, in this solution, the entrance pupil of the detection lens overlaps with its own aperture stop, which will result in a lens being provided only on one side of the aperture stop along the direction from the light incident end to the light emergent end. This positional relationship causes the optical system to be asymmetric on both sides of the aperture stop, and this imaging method is more likely to produce the aberration. In this regard, this solution provide the first lens group in the detection lens, and the first lens group may also play a role in providing an intermediate image for the second lens group. That is, as shown in FIG. 1, after optical processing by the first lens group, the first lens group may image the image of the AR or VR device between the first lens group and the second lens group. The second lens group receives the real image between the first lens group and the second lens group, and further performs aberration processing. By performing a real image imaging between the first lens group and the second lens group, it helps to solve the problem of asymmetry of the optical system. The real image imaging between the first lens group and the second lens group is equivalent to the entrance pupil of the second lens group.

The head-mounted display mentioned in this solution may be the virtual reality device (VR), augmented reality device (AR) and other devices that need to be worn on the head and viewed from a close distance by a user. Such devices all have the problem of being unable to effectively simulate the observation form of the human eye during detection. The detection lens provided by this solution may solve the simulation problem.

Optionally, the first lens group and the second lens group can form a flat-field lens group “f-tan(theta) lens”, or they can form a fisheye lens group “f-theta lens”. The final imaging effect of the flat-field lens group has low distortion, and the image is in a tiled state. This type of lens group can uniformly utilize the pixels of the image sensor to display the projection effect of the head-mounted display for subsequent analysis.

The final imaging effect of the fisheye lens group has high distortion, and the image is barrel distorted. The central area of the image is imaged normally, while the surrounding area presents a curved, annularly deformed image. This form of distortion of the fisheye lens group helps to increase the overall angle of view of the detection lens, which can be used to detect images within a larger angle of view. The image projected by the head-mounted display to be detected may occupy a larger angle of view relative to the human eye at the observation position. In order to be able to detect display images within a larger angle of view, the detection lens also needs to have detection performance with a large angle of view.

Optionally, the diameter of the aperture stop is less than 5 mm, and can be chosen to be 4 mm. On one hand, the size of the aperture stop simulates the normal size of the human eye's pupil; on the other hand, by controlling the size of the aperture stop, the field of view angle of the detection lens can also be defined in an auxiliary way, simulating the working conditions when the head-mounted display is actually used.

Optionally, the overall diameter of the first lens group and the second lens group is less than or equal to 65 mm, for example, it can be 40 mm. This design ensures that the diameter of the detection lens is not too large, which would otherwise prevent the light incident end from getting close to the exit pupil position of the head-mounted display in practical applications. Head-mounted displays often have specific shapes, and the space available for placing the detection lens is limited. Since the diameter of the detection lens is relatively small, achieving a relatively large field of view angle is more challenging. In this case, the present technical solution achieves a large field of view angle with a small diameter by configuring the first lens group with a condenser lens and the double-Gauss lens group.

Optionally, the first lens group can move along the axial direction of the detection lens, and its axial movement can achieve the focusing detection of the detection lens, allowing the image projected by the head-mounted display to be accurately focused and imaged on the image sensor 4.

In a preferred embodiment, the second lens group as a whole can move along the axial direction of the detection lens. The second lens group has a relatively longer overall focal length, and its axial movement can more accurately achieve the focusing of the lens, facilitating the precise acquisition of the image projected by the head-mounted display. This design approach can minimize the imaging error of the detection lens itself, thereby accurately reflecting the imaging effect of the head-mounted display to be detected.

Optionally, the detection lens includes an image sensor 4, which is set at the light emergent end of the detection lens and is used to receive the light and image processed by the detection lens. The image sensor 4 images the projection from the head-mounted display to analyze the display effect.

This technical solution provides different embodiments for the detection lens according to the different sizes of the field of view angle. The field of view angle range of the detection lens provided by this technical solution can adapt to a specific value within the range from a 55-degree field of view angle to a 125-degree field of view angle.

In a first aspect, for detection lenses with a relatively small field of view angle, the following optional embodiment is provided. The field of view angle range of the detection lens is from 55 degrees to 70 degrees, for example, it can be a 60-degree field of view angle. The first lens group includes one or two condenser lenses, each arranged sequentially from the light incident end to the light emergent end within the first lens group. That is, along the direction from the light incident end to the light emergent end, each condenser lens is located close to the light incident end.

Optionally, the overall effective focal length range of the first lens group can be selected to be from 20 mm to 40 mm, and the overall effective focal length range of the second lens group can be selected to be from 40 mm to 200 mm. Preferably, this range can be within 70 mm-120 mm. The overall effective focal length matching of the first lens group and the second lens group enables the field of view angle of the detection lens to be less than or equal to 70 degrees. This design approach makes the detection field of the detection lens conform to the comfortable observation characteristics of the human eye, and it can detect the display image of the head-mounted display at close range. The magnification range of the second lens group can be controlled to be between 0.5 and 2 times. The second lens group, through this magnification range, can provide a certain degree of image zoom while reducing image aberrations, achieving an appropriate detection effect.

Optionally, the effective focal length range of the first lens group can be within 23 mm to 30 mm. This facilitates the formation of a field of view angle that is less than or equal to 70 degrees for the detection lens. If the effective focal length of the first lens group is too short, forming a field of view angle less than or equal to 70 degrees would affect the number of lenses in the first and second lens groups, as well as the length along the direction of the detection lens. If the effective focal length of the first lens group is too long, it would be necessary to adjust the diameter of the first lens group and the detection lens to achieve a suitable field of view angle. Moreover, in the embodiment where the effective focal length of the first lens group falls within the aforementioned range, when combined with a second lens group having an effective focal length range of 70 mm-120 mm, it is possible to accurately acquire and image the scene within a field of view angle less than or equal to 70 degrees. When the effective focal length ranges of the second lens group and the first lens group are matched within the aforementioned range, the imaging accuracy is higher, allowing for more effective detection of the imaging effects of head-mounted displays.

Optionally, the magnification range of the second lens group can be between 0.7 and 1.3 times. Within this range, the second lens group can more reliably correct aberrations in the image formed by the first lens group. If the magnification of the second lens group is too high, the size of the aberrations that need to be corrected will also increase, which will increase the difficulty of aberration correction. To correct larger aberrations, the diameter of the second lens group may need to be increased, and the number of lenses it contains may also need to be increased. If the magnification of the second lens group is too small, the aberrations that need to be adjusted and corrected are too subtle, which increases the precision requirements for the lenses in the second lens group. If the molding accuracy of the lenses in the second lens group is not sufficient, it may not be possible to adjust the subtle aberrations. Therefore, this scheme preferably adopts a second lens group with a magnification between 0.7 and 1.3 times to better achieve aberration correction.

Optionally, in a specific embodiment, the effective focal length of the first lens group is 25.1 mm, the effective focal length of the second lens group is 92.3 mm, and the magnification of the second lens group is 0.86 times. In this embodiment, the detection lens can accurately detect the light images projected by the head-mounted display within a 60-degree field of view angle and correct for the aberrations generated by its own image acquisition.

FIG. 1 illustrates the distribution of the first and second lens groups in this embodiment. FIG. 2 shows the field aberration diagrams for different wavelengths of light in this embodiment. FIG. 2(a) is a longitudinal spherical aberration diagram, reflecting the effect of the overall lens on the longitudinal spherical aberration of light, with the first and second lens groups of this embodiment limiting spherical aberration to a finite range. FIG. 2(b) is an astigmatism field curve diagram, reflecting the effect of the overall lens on astigmatism of light. The first and second lens groups of this embodiment limit astigmatism to a smaller extent. FIG. 2(c) is a distortion diagram, used to measure the distortion effect of the overall lens on the image. With the image sensor 4 used in the detection lens capable of receiving light in a tiled manner across the entire field of view angle, the first and second lens groups can minimize image and light distortion, resulting in a tiled imaging effect.

The different lines in FIG. 2(a) to (c) represent light of different wavelengths.

In the aforementioned embodiment, the image sensor 4 may optionally have pixels of less than or equal to 4.5 microns, and its color registration can be controlled to be less than or equal to half the pixel size, that is, 2.25 microns. An image sensor 4 with pixels of less than or equal to 4.5 microns can usually clearly acquire the image of the micro-distance display, facilitating analysis and testing of the display effect. In practical applications, an image sensor 4 with even smaller pixel points can also be used.

Optionally, as shown in FIG. 1, for the embodiment using the flat-field lens group “f-tan(theta) lens,” the first lens group may include two condenser lenses, namely the first condenser lens 11 and the second condenser lens 12. As shown in FIG. 1, the first condenser lens 11 and the second condenser lens 12 are arranged along the direction from the light incident end to the light emergent end. The first condenser lens 11 is located on the side of the second condenser lens close to the light incident end.

### Embodiment One

The following explanation of this technical solution is based on the flat-field lens group as shown in FIG. 1, where the field of view angle of the detection lens in this embodiment approaches 60 degrees.

The first condenser lens 11 and the second condenser lens 12 converge light within a field of view less than or equal to 70 degrees into the detection lens to achieve the acquisition of this light.

Optionally, the range of the radius of curvature of the light incident surface of the first condenser lens 11 is from −14.5 mm to −16.5 mm, the range of the radius of curvature of the light emergent surface of the first condenser lens 11 is from −12.5 mm to −14.5 mm, and the thickness range of the first condenser lens 11 is from 2.7 mm to 3.9 mm.

For example, in one embodiment, the radius of curvature of the light incident surface of the first condenser lens 11 is −15.5 mm, the radius of curvature of the light emergent surface of the first condenser lens 11 is −13.5 mm, and the thickness of the first condenser lens 11 is 3.2 mm.

Optionally, the range of the radius of curvature of the light incident surface of the second condenser lens 12 is from −55.0 mm to −64.0 mm, the range of the radius of curvature of the light emergent surface of the second condenser lens 12 is from −27.0 mm to −33.5 mm, and the thickness range of the second condenser lens 12 is from 4.5 mm to 6.5 mm.

For example, in one embodiment, the radius of curvature of the light incident surface of the second condenser lens 12 is −58.6 mm, the radius of curvature of the light emergent surface of the second condenser lens 12 is −30.8 mm, and the thickness of the second condenser lens 12 is 5.7 mm.

Optionally, the spacing range between the first condenser lens 11 and the second condenser lens 12 is from 2.5 mm to 5.0 mm. For instance, in one embodiment, the spacing between the first condenser lens 11 and the second condenser lens 12 is 3.7 mm.

In the aforementioned embodiment of the first condenser lens 11 and the second condenser lens 12, the two condenser lenses can accurately gather light within approximately a 60-degree field of view into the detection lens and parallelize the direction of light irradiation, so that the light is irradiated onto subsequent lenses with minimal aberration. If the radii of curvature of the light incident and emergent surfaces of the first and second condenser lenses differ significantly from the aforementioned ranges, increased aberration may occur after the image light passes through the condenser lenses, thereby increasing the difficulty of subsequent aberration correction. The focal length of the first condenser lens 11 is less than that of the second condenser lens 12, allowing light entering from the light incident end to gradually propagate towards the axis of the detection lens, tending to be parallel. This gentle refractive effect helps to reduce the occurrence of aberrations between different wavelengths of light.

In addition to the first condenser lens 11 and the second condenser lens 12, the first lens group may also include multiple lenses to form an intermediate real image after the light passes through the first lens group.

In one optional embodiment, the first lens group includes the aforementioned first condenser lens 11 and second condenser lens 12, as well as three primary collimating lenses. The three primary collimating lenses are arranged in sequence from the light incident end to the light emergent end as lenses 13, 14, and 15 in the table below.

TABLE 1

| | Radius of | Radius of | | Distance from |
|---|---|---|---|---|
| | curvature | curvature | | the lens on |
| | of light | of light | | the side of |
| | incident | emergent | Thickness | the light |
| | surface mm | surface mm | of lens mm | emergent end mm |
| First | −15.515 | −13.57 | 3.216 | 3.797 |
| condenser | | | | |
| lens 11 | | | | |
| Second | −58.697 | −30.833 | 5.7 | 10.629 |
| condenser | | | | |
| lens 12 | | | | |
| Lens 13 | 80.069 | 30.742 | 3.5 | 0 |
| Lens 14 | 30.742 | −100.293 | 8.21 | 4.237 |
| Lens 15 | 37.516 | 256.013 | 5.52 | 3.854 |

Table 1 presents an embodiment of a flat-field lens group “f-tan(theta) lens” in this technical solution, as shown in FIG. 1. On the side of the light emergent end of lens 15, it is the real image formed by the first lens group in the detection lens. The distance from lens 15 to this real image along the optical axis is 3.854000 mm. On the side of the light incident end of the first condenser lens 11, there is the real image (exit pupil) projected by the head-mounted display. The distance from this real image to the first condenser lens 11 along the optical axis is 11.472000 mm. Specifically, in this technical solution, the light incident end coincides with the real image projected by the head-mounted display, meaning the distance between the light incident end and the first condenser lens 11 can also be 11.472000 mm. As shown in FIG. 1, the field of view angle of this optional specific embodiment is close to 60 degrees.

As described above, the second lens group is used to compensate for aberrations generated during the overall imaging process, ultimately forming an image on the image sensor 4 located at the light emergent end. Optionally, the second lens group may include a double-Gauss lens group and a collimating lens group.

As shown in FIG. 1, the double-Gauss lens group may consist of six lenses, wherein the first three lenses converge the light, and the last three lenses further adjust the lights to form scattered, relatively parallel lights. These six lenses are arranged in sequence from the light incident end to the light emergent end as Gauss lens 21, Gauss lens 22, Gauss lens 23, Gauss lens 24, Gauss lens 25, and Gauss lens 26.

The parameters of various lenses in the double-Gauss lens group for this embodiment are presented in the following Table 2:

TABLE 2

| | | | | Distance from |
|---|---|---|---|---|
| | Radius of | Radius of | | the lens on |
| | curvature | curvature | | the side of |
| | of light | of light | Thickness | the light |
| | incident | emergent | of lens | emergent |
| | surface mm | surface mm | mm | end mm |
| Gauss lens 21 | 27.267 | 36.37 | 9.346 | 0.723 |
| Gauss lens 22 | 16.0 | 13.644 | 7.757 | 3.605 |
| Gauss lens 23 | −56.075 | 14.851 | 7.567 | 14.569 |
| Gauss lens 24 | −12.154 | −22.985 | 10.2 | 0.556 |
| Gauss lens 25 | −54.368 | −25.95 | 7.23 | 0.731 |
| Gauss lens 26 | 75.733 | −1254.1 | 4.72 | 28.338 |

Table 2 presents the parameters of each lens in the double-Gauss lens group of the flat-field lens group “f-tan(theta) lens” as shown in FIG. 1. As depicted in FIG. 1, on the side of the light emergent end of lens 15, it is the other lenses of the second lens group within the detection lens, and the distance along the optical axis from Gauss lens 26 to the next lens is 28.338000 mm. On the side of the light incident end of Gauss lens 21, it is the real image (exit pupil) formed by the first lens group in the detection lens, and the distance from this real image to Gauss lens 21 along the optical axis is 13.369000 mm. In this technical solution, the double-Gauss lens group converges and then diverges the various color rays of the image to compensate for the aberrations of light of different wavelengths, reducing the interference of aberrations on imaging detection.

As shown in FIG. 1, the collimating lens group may consist of six lenses. In this embodiment, the various collimating lenses are, in sequence, collimating lens 31, collimating lens 32, collimating lens 33, collimating lens 34, collimating lens 35, and collimating lens 36. The collimating lens group is used to converge the scattered light processed by the double-Gauss lens group into a regionally parallel beam, and the lights of various colors of different wavelengths converge again into a regionally parallel image, facilitating imaging on the image sensor 4 at the light emergent end.

The parameters of various lenses in the collimating lens group for this embodiment are resented in the following Table 3:

TABLE 3

| | Radius of | Radius of | | Distance from |
|---|---|---|---|---|
| | curvature | curvature | | the lens on |
| | of light | of light | Thickness | the side of |
| | incident | emergent | of lens | the light |
| | surface mm | surface mm | mm | emergent end mm |
| Collimating | 26.62 | 59.47 | 4.731 | 12.428 |
| lens 31 | | | | |
| Collimating | 96.42 | 19.011 | 3.33 | 0 |
| lens 32 | | | | |
| Collimating | 19.011 | −44.652 | 5.88 | 0.3 |
| lens 33 | | | | |
| Collimating | 30.62 | −21.848 | 6.13 | 0 |
| lens 34 | | | | |
| Collimating | −21.848 | 33.927 | 5.5 | 26.411 |
| lens 35 | | | | |
| Collimating | ∞ | −55.104 | 4.528 | 49.112 |
| lens 36 | | | | |

Table 3 shows parameters of various lenses of the collimating lens group of the flat-field lens group “f-tan (theta) lens” in the solution shown in FIG. 1, as shown in FIG. 1. Wherein, on the side of the light emergent end of the collimating lens 36, it is the image sensor 4, and the distance between the collimating lens 36 and the image sensor 4 along the optical axis is 49.112000 mm. In particular, the light incident surface of the collimating lens 36 tends to be flat, which minimizes the aberration generated again after the light enters into the collimating lens 36, and the collimating lens 36 is used to calibrate the direction of the image light so that the light is irradiated on the image sensor 4 in a parallel form. On the side of light incident end of the collimating lens 31, it is the last Gauss lens of the second lens group, that is, Gauss lens 26.

Optionally, in this solution, different glass materials may be used for different lenses to achieve better optical effects. Different glass materials have different refractive indices and astigmatism effects on light of different wavelengths. The glass material may be selected from existing standard glass materials. Taking the technical solution shown in FIG. 1 as an example, for the first lens group, the glass number of the first condenser lens 11 is 946179, the glass number of the second condenser lens 12 is 805255, the glass number of lens 13 is 673322, the glass number of lens 14 is 593683, and the glass number of lens 15 is 438945.

For the double-Gauss lens group, the glass number of gauss lens 21 and gauss lens 22 is 835427, the glass number of gauss lens 23, gauss lens 24 and gauss lens 25 is 593683, and the glass number of gauss lens 26 is 805255.

For the collimating lens group, the glass number of the collimating lens 31 is 593683, the glass number of the collimating lens 32 is 850300, the glass number of the collimating lens 33 is 438945, the glass number of the collimating lens 34 is 593683, the glass number of the collimating lens 35 is 850300, and the glass number of the collimating lens 36 is 805255.

FIG. 2 shows the limiting effect of the embodiment shown in FIG. 1 on image aberration. FIG. 2(a) is a schematic diagram of longitudinal spherical aberration; FIG. 2(b) is a schematic diagram of field astigmatism; FIG. 2(c) is a schematic diagram of distortion. The distortion amount in the present implementation is controlled below 0.2, and the first lens group and the second lens group form a flat-field lens group.

Optionally, the diameter of the aperture stop ranges from 3.8 mm to 4.2 mm, preferably being 4 mm. The overall diameter of the first and second lens groups is less than or equal to 40 mm, for example, it can be 35 mm or 38 mm.

In another optional specific embodiment of this technical solution, a fisheye lens group “f-theta lens” can be used.

### Embodiment Two

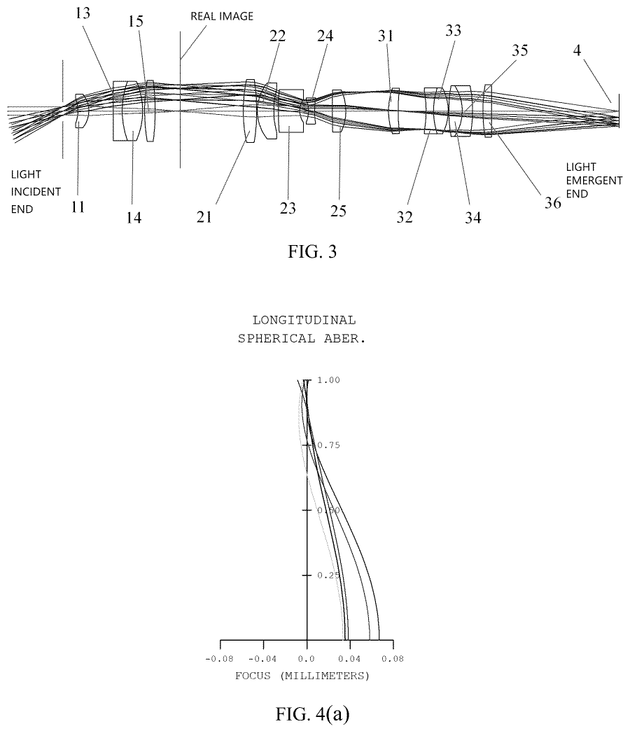

FIG. 3 illustrates an embodiment using a fisheye lens group, and the following explanation of this solution is based on the embodiment shown in FIG. 3. The field of view angle of the detection lens in this embodiment approaches 60 degrees.

The first lens group may include a first condenser lens, and with a single first condenser lens, light within a field of view of approximately 60 degrees of the detection lens can converge into the detection lens to acquire the light. Since barrel distortion is allowed, no more condenser lenses are needed.

Optionally, in this embodiment, the range of the radius of curvature of the light incident surface of the first condenser lens is from −15.3 mm to 17.2 mm, the range of the radius of curvature of the light emergent surface of the first condenser lens is from −11.8 mm to 13.3 mm, and the thickness range of the first condenser lens is from 4.5 mm to 5.5 mm.

For example, in one embodiment, the radius of curvature of the light incident surface of the first condenser lens is −16.4 mm, the radius of curvature of the light emergent surface is −12.6 mm, and the thickness of the first condenser lens is 5.0 mm.

In the aforementioned embodiment of the condenser lens, the first condenser lens can accurately converge light within a field of view of about 60 degrees into the detection lens and process the direction of the light irradiation to converge it onto subsequent lenses, which may result in barrel distortion. Further optical processing by subsequent lenses may also result in barrel distortion, eventually forming an image with distortion. The advantage of this embodiment is that the expected field of view can be achieved with fewer condenser lenses, or a very large field of view can be obtained by using a greater number of condenser lenses. In the edge areas of the resulting image, to accommodate more light, a pixel point receives more light compared to the embodiment using a flat-field lens. This also causes a relative change in the aberration detection of the edge areas of the image.

In addition to the first condenser lens, the first lens group may also include multiple lenses to form an intermediate real image after the light passes through the first lens group.

In one optional embodiment, the first lens group includes the aforementioned condenser lens and three primary collimating lenses, which are arranged sequentially from the light incident end to the light emergent end as lenses 13, 14, and 15 in the table below.

The parameters of various lenses in the first lens group for this embodiment are presented in the following Table 4:

TABLE 4

| | Radius of | Radius of | | Distance from |
|---|---|---|---|---|
| | curvature | curvature | | the lens on |
| | of light | of light | | the side of |
| | incident | emergent | Thickness | the light |
| | surface mm | surface mm | of lens mm | emergent end mm |
| Condenser | −16.431 | −12.627 | 5.066 | 11.384 |
| lens 11 | | | | |
| Lens 13 | −3331.34 | 40.870 | 4.223 | 0 |
| Lens 14 | 40.87 | −34.681 | 9.510 | 0.928 |
| Lens 15 | 86.018 | −115.293 | 4.922 | 9.759 |

Table 4 presents an implementation of a fisheye lens group “f-theta lens” in this solution, as shown in FIG. 3. Here, on the side of the light emergent end of lens 15, it is the real image presented by the first lens group in the detection lens, and the distance from lens 15 to this real image along the optical axis is 9.759451 mm. On the side of the light incident end of the condenser lens, it is the real image (exit pupil) projected by the head-mounted display, and the distance from this real image to the condenser lens along the optical axis is 11.383582 mm. Specifically, in this technical solution, the light incident end coincides with the real image projected by the head-mounted display, meaning the distance between the light incident end and the condenser lens can also be 11.383582 mm. As shown in FIG. 3, the field of view angle of this optional specific implementation is close to 60 degrees.

As described above, the second lens group is used to compensate for aberrations generated during the overall imaging process, ultimately forming an image on the image sensor 4 located at the light emergent end. The second lens group may include a double-Gauss lens group and a collimating lens group.

As shown in FIG. 3, the double-Gauss lens group may consist of five lenses, where the first three lenses converge the light, and the last two lenses further adjust the light to form scattered, relatively parallel rays. These five lenses are arranged sequentially from the light incident end to the light emergent end as Gauss lenses 21, 22, 23, 24, and 25.

The parameters of various lenses in the double-Gauss lens group for this embodiment are presented in the following Table 5:

TABLE 5

| | Radius of | Radius of | | Distance from |
|---|---|---|---|---|
| | curvature of | curvature of | | the lens on the |
| | light incident | light emergent | Thickness | side of the light |
| | surface mm | surface mm | of lens mm | emergent end mm |
| Gauss | 72.667 | −93.647 | 6.272 | 0.3 |
| lens 21 | | | | |
| Gauss | 21.207 | 38.175 | 7.657 | 2.151 |
| lens 22 | | | | |
| Gauss | 121.107 | 9.699 | 10.0 | 4.054 |
| lens 23 | | | | |
| Gauss | −14.575 | 41.362 | 2.863 | 8.312 |
| lens 24 | | | | |
| Gauss | 1530.074 | −23.294 | 6.272 | 19.944 |
| lens 25 | | | | |

Table 5 shows parameters of various lenses of the double-Gauss lens group of the fisheye lens group “f-theta lens” in the solution shown in FIG. 3, as shown in FIG. 3. Wherein, on the side of the light emergent end of the gauss lens 25, it is the other lenses of the second lens group in the detection lens, and the distance along the optical axis between gauss lens 25 and the next lens is 19.944443 mm. On the side of the light incident end of the gauss lens 21, it is the real image (exit pupil) formed by the first lens group in the detection lens, and the distance along the optical axis between the real image and gauss lens 21 is 31.371480 mmmm. In this solution, the double-Gauss lens group converges and then scatters the various colors of light of the image to compensate for the aberration of light of different wavelengths and reduce the interference of aberration on imaging detection.

As shown in FIG. 3, the collimating lens group may comprise six lenses. In this embodiment, the various collimating lenses are collimating lens 31, collimating lens 32, collimating lens 33, collimating lens 34, collimating lens 35, and collimating lens 36 in sequence. The collimating lens group is used to converge the scattered light processed by the double-Gauss lens group into a regionally parallel beam, and the lights of various colors of different wavelengths converge into a regionally parallel image again, so as to facilitate imaging on the image sensor 4 at the light emergent end.

The parameters of various lenses in the collimating lens group for this embodiment are presented in the following Table 6:

TABLE 6

| | | | | Distance from |
|---|---|---|---|---|
| | Radius of | Radius of | | the lens on |
| | curvature | curvature | | the side of |
| | of light | of light | | the light |
| | incident | emergent | Thickness | emergent |
| | surface mm | surface mm | of lens mm | end mm |
| Collimating | 33.058 | 87.49 | 4.471 | 13.034 |
| lens 31 | | | | |
| Collimating | −55.029 | 34.691 | 3.5 | 6.829 |
| lens 32 | | | | |
| Collimating | 34.691 | −23.105 | 6.829 | 0.3 |
| lens 33 | | | | |
| Collimating | 67.978 | −21.865 | 6.269 | 4.835 |
| lens 34 | | | | |
| Collimating | −21.865 | −58.851 | 4.835 | 4.837 |
| lens 35 | | | | |
| Collimating | 75.879 | −1729.449 | 4.0 | 59.579 |
| lens 36 | | | | |

Table 6 shows parameters of various lenses of the collimating lens group of the fisheye lens group “f-theta lens” in the solution shown in FIG. 3, as shown in FIG. 3. Wherein, on the side of the light emergent end of the collimating lens 36, it is the image sensor 4, and the distance between the collimating lens 36 and the image sensor 4 along the optical axis is 59.579339 mm. In particular, the light incident exit of the collimating lens 36 tends to be flat, which minimizes the aberration generated again after the light is emitted from the collimating lens 36, and the collimating lens 36 is used to calibrate the direction of the image light so that the light is irradiated on the image sensor 4 in a converged form. On the side of light incident end of the collimating lens 31, it is the last Gauss lens of the second lens group, that is, Gauss lens 25.

Optionally, in this solution, different glass materials may be used for different lenses to achieve better optical effects. Different glass materials have different refractive indices and astigmatism effects on light of different wavelengths. The glass material may be selected from existing standard glass materials. Taking the technical solution shown in FIG. 3 as an example, for the first lens group, the glass number of the first condenser lens 11 is 946179, the glass number of lens 13 is 805255, the glass number of lens 14 is 593683, and the glass number of lens 15 is 729547.

For the double-Gauss lens group, the glass number of gauss lens 21 and gauss lens 22 is 835427, and the glass number of gauss lens 23, gauss lens 24 and gauss lens 25 is 805255.

For the collimating lens group, the glass number of the collimating lens 31 is 805255, the glass number of the collimating lens 32 is 438945, the glass number of the collimating lens 33 is 438945, the glass number of the collimating lens 34 is 593683, the glass number of the collimating lens 35 is 805255, and the glass number of the collimating lens 36 is 805255.

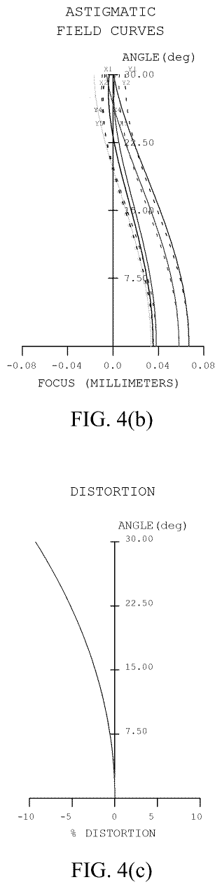

FIG. 4 shows the limiting effect of the embodiment shown in FIG. 3 on image aberration. FIG. 4(a) is a schematic diagram of longitudinal spherical aberration; FIG. 4(b) is a schematic diagram of field astigmatism; FIG. 4(c) is a schematic diagram of distortion. The aberration in the present implementation is large, and the first lens group and the second lens group form the fisheye lens group.

The above describes an optional implementation of this technical solution for a field of view angle between 55 degrees and 70 degrees.

In a second aspect, for detection lenses with a relatively large field of view, this solution provides the following optional implementation methods. The field of view angle of the detection lens ranges from 70 degrees to 125 degrees, for example, it can be a 90-degree field of view angle or a 120-degree field of view angle. The first lens group includes two or three condenser lenses, each arranged sequentially from the light incident end to the light emergent end within the first lens group. That is, along the direction from the light incident end to the light emergent end, each condenser lens is located close to the light incident end.

Optionally, the overall effective focal length range of the first lens group can be selected to be from 15 mm to 22 mm, and the overall effective focal length range of the second lens group can be selected to be from 100 mm to 500 mm. Preferably, this range can be within 110 mm to 350 mm. The overall effective focal length matching of the first lens group and the second lens group enables the field of view angle of the detection lens to be between 70 degrees and 125 degrees. The detection lens designed with this approach has a wide field of view angle range, which can complete the detection of the display effect of VR and AR head-mounted displays with a large range of display effects in one go, without the need to adjust the relative positions of the display devices and the detection lens. The magnification range of the second lens group can be controlled between 0.75 and 1.2 times. The second lens group, through this magnification range, can provide a certain degree of image zoom while reducing image aberrations, achieving an appropriate detection effect.

For the effective focal lengths of the first and second lens groups, if the effective focal length of the first lens group is too short, forming a field of view angle of 70 to 120 degrees will affect the number of lenses in the first and second lens groups and the length along the detection lens direction. If the effective focal length of the first lens group is too long, it will be necessary to adjust the diameter of the first lens group and the detection lens to achieve a suitable field of view angle. Moreover, in the implementation where the effective focal length of the first lens group falls within the aforementioned range, when matched with the second lens group with an effective focal length range of 110 mm to 350 mm, it can accurately acquire and image the scene within a field of view angle of 70 to 125 degrees. When the effective focal length range of the second lens group matches that of the first lens group within the aforementioned range, its imaging accuracy is higher, and it can more effectively detect the imaging effect of the head-mounted display.

For the magnification range of the second lens group between 0.75 and 1.2 times, the second lens group can more reliably correct the aberrations of the image formed by the first lens group. On the one hand, there is no need to correct large aberrations, and on the other hand, there is no need to have excessively high precision requirements for the lenses of the second lens group.

Optionally, in a specific implementation, the effective focal length of the first lens group is 17.2 mm, the effective focal length of the second lens group is 126 mm, and the magnification of the second lens group is 1.1 times. In this embodiment, the detection lens can accurately detect the light images projected by the head-mounted display within a 90-degree field of view angle and correct for the aberrations generated by its own image acquisition.

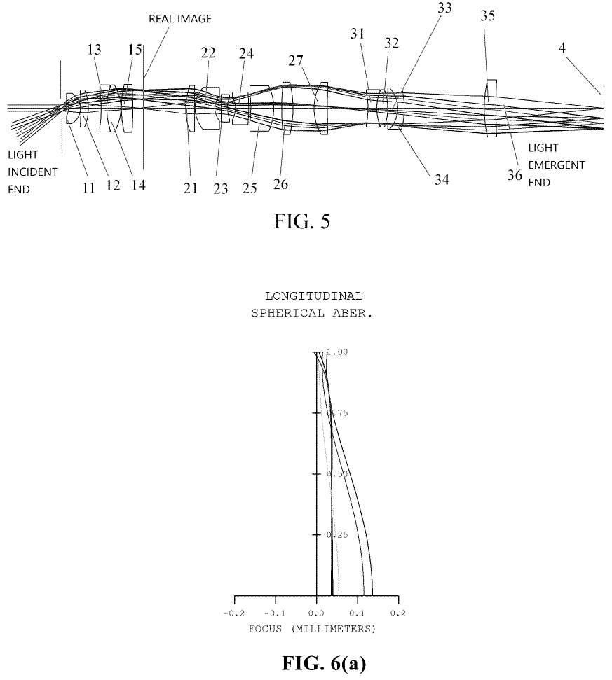

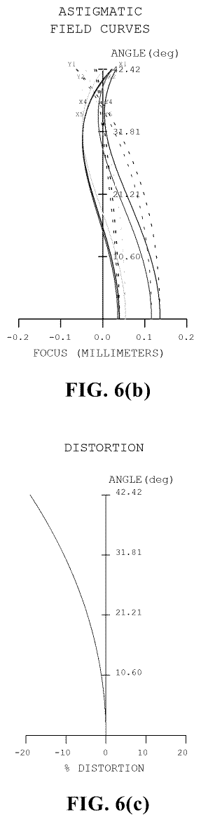

FIG. 5 shows the distribution of the first and second lens groups in this embodiment. FIG. 6 shows the field aberration diagrams for different wavelengths of light in this embodiment. FIG. 6(a) is a longitudinal spherical aberration diagram, reflecting the effect of the overall lens on the longitudinal spherical aberration of light, with the first and second lens groups of this embodiment limiting spherical aberration to a finite range. FIG. 6(b) is an astigmatism field curve diagram, reflecting the effect of the overall lens on astigmatism of light. The first and second lens groups of this embodiment limit astigmatism to a smaller extent. FIG. 6(c) is a distortion diagram, used to measure the distortion effect of the overall lens on the image. In this embodiment, the first and second lens groups project image light in a form that creates barrel distortion, so as to be able to project the entire field of view angle range of image light onto the image sensor 4.

The different lines in FIG. 6(a) to (c) represent light of different wavelengths.

In the aforementioned implementation, the image sensor 4 may optionally have pixels of less than or equal to 4.5 microns, and its color registration can be controlled to be less than or equal to 4 microns. An image sensor 4 with pixels of less than or equal to 4.5 microns can usually clearly capture the image of the micro-distance display, facilitating analysis and testing of the display effect. In practical applications, an image sensor 4 with even smaller pixel points can also be used. In particular, using color registration within a range of 4 microns can better utilize the edge parts of the image sensor to image light over a wide-angle range.

Optionally, for the implementation using the fisheye lens group “f-theta lens,” this technical solution provides two embodiments.

In the first set of implementation schemes, the first lens group may include two condenser lenses, namely the first condenser lens 11 and the second condenser lens 12. As shown in FIG. 5, the first condenser lens 11 and the second condenser lens 12 are arranged sequentially from the light incident end to the light emergent end. The first condenser lens 11 is located on the side of the second condenser lens 12 close to the light incident end.

### Embodiment Three

The following explanation of this technical solution is based on the fisheye lens group shown in FIG. 5. The field of view angle of the detection lens in this embodiment approaches between 70 degrees and 95 degrees. For example, the field of view angle is approximately equal to 90 degrees.

The first condenser lens 11 and the second condenser lens 12 converge light within the range of 70 to 95 degrees of the field of view angle into the detection lens to acquire these lights.

Optionally, the range of the radius of curvature of the light incident surface of the first condenser lens 11 is from −9.2 mm to −12.0 mm, the range of the radius of curvature of the light emergent surface of the first condenser lens 11 is from −10.4 mm to −12.1 mm, and the thickness range of the first condenser lens 11 is from 6.5 mm to 8.4 mm.

For example, in this embodiment, the radius of curvature of the light incident surface of the first condenser lens 11 is −10.67 mm, the radius of curvature of the light emergent surface is −11.24 mm, and the thickness of the first condenser lens 11 is 7.47 mm.

Optionally, the range of the radius of curvature of the light incident surface of the second condenser lens 12 is from −140.0 mm to −152.0 mm, the range of the radius of curvature of the light emergent surface of the second condenser lens 12 is from −27.0 mm to −33.5 mm, and the thickness range of the second condenser lens 12 is from 4.2 mm to 5.1 mm.

For example, in this embodiment, the radius of curvature of the light incident surface of the second condenser lens 12 is −150.97 mm, the radius of curvature of the light emergent surface is −30.85 mm, and the thickness of the second condenser lens 12 is 4.64 mm.

Optionally, the spacing range between the first condenser lens 11 and the second condenser lens 12 is from 0.2 mm to 0.4 mm. For example, the spacing between the first condenser lens 11 and the second condenser lens 12 is 0.3 mm.

In the aforementioned embodiment, the two condenser lenses can accurately converge light within a field of view angle of about 90 degrees into the detection lens and process the direction of light irradiation to be parallel, so that the light is irradiated onto subsequent lenses with minimal aberration. If the radii of curvature of the light incident and emergent surfaces of the first and second condenser lenses differ significantly from the aforementioned ranges, increased aberration may occur after the image light passes through the condenser lenses, thereby increasing the difficulty of subsequent aberration correction. The focal length of the first condenser lens 11 is less than that of the second condenser lens 12. After the light enters from the light incident end, it gradually propagates towards the direction close to the axis of the detection lens, and the light tends to be parallel. This gentle refractive effect helps to reduce the occurrence of aberrations between different wavelengths of light.

The first lens group, in addition to including the first condenser lens 11 and the second condenser lens 12, may also comprise multiple lenses to enable the formation of an intermediate real image after the light passes through the first lens group.

In an optional embodiment, the first lens group includes the aforementioned first condenser lens 11 and second condenser lens 12, as well as three primary collimating lenses. These three primary collimating lenses are sequentially arranged from the light incident end to the light emergent end as lenses 13, 14, and 15 in the table below.

The parameters of various lenses in the collimating lens group for this embodiment are presented in the following Table 7:

TABLE 7

| | Radius of | Radius of | | Distance from |
|---|---|---|---|---|
| | curvature of | curvature of | | the lens on the |
| | light incident | light emergent | Thickness | side of the light |
| | surface | surface | of lens | emergent end |
| | mm | mm | mm | mm |
| First | −10.675 | −11.246 | 7.473 | 0.300 |
| condenser | | | | |
| lens 11 | | | | |
| Second | −150.971 | −30.858 | 4.641 | 7.958 |
| condenser | | | | |
| lens 12 | | | | |
| Lens 13 | −82.696 | 43.977 | 3.502 | 0.000 |
| Lens 14 | 43.977 | −29.100 | 8.765 | 0.338 |
| Lens 15 | 65.085 | −186.441 | 7.118 | 4.323 |

Table 7 presents an implementation of the fisheye lens group “f-theta lens” in this solution, as shown in FIG. 5. Here, on the side of the light emergent end of lens 15, it is the real image presented by the first lens group in the detection lens, and the distance from lens 15 to this real image along the optical axis is 4.322982 mm. On the side of the light incident end of the first condenser lens 11, it is the real image (exit pupil) projected by the head-mounted display, and the distance from this real image to the first condenser lens 11 along the optical axis is 4.080794 mm. Specifically, in this technical solution, the light incident end coincides with the real image projected by the head-mounted display, meaning the distance between the light incident end and the first condenser lens 11 can also be 4.080794 mm. As shown in FIG. 5, the field of view angle of this optional specific implementation approaches 90 degrees.

As described above, the second lens group is used to compensate for aberrations generated during the overall imaging process, ultimately forming an image on the image sensor 4 located at the light emergent end. Optionally, the second lens group may include a double-Gauss lens group and a collimating lens group.

Optionally, the double-Gauss lens group includes at least three Gauss lenses, which are the first Gauss lens 21, the second Gauss lens 22, and the third Gauss lens 23, arranged sequentially from the light incident end to the light emergent end.

Optionally, the radius of curvature of the light incident surface of the first Gauss lens 21 ranges from 38.0 mm to 42.0 mm, the radius of curvature of the light emergent surface of the first Gauss lens 21 ranges from 2000 mm to infinity, and the thickness of the first Gauss lens 21 ranges from 5.0 mm to 6.0 mm.

For example, in one embodiment, the radius of curvature of the light incident surface of the first Gauss lens 21 is 40.5 mm, the radius of curvature of the light emergent surface of the first Gauss lens 21 is 2854.9 mm, and the thickness of the first Gauss lens 21 is 5.59 mm.

Optionally, the radius of curvature of the light incident surface of the second Gauss lens 22 ranges from 18.5 mm to 21.5 mm, the radius of curvature of the light emergent surface of the second Gauss lens 22 ranges from 10.7 mm to 14.0 mm, and the thickness of the second Gauss lens 22 ranges from 11.5 mm to 13.5 mm.

For example, in one embodiment, the radius of curvature of the light incident surface of the second Gauss lens 22 is 20.1 mm, the radius of curvature of the light emergent surface of the second Gauss lens 22 is 12.2 mm, and the thickness of the second Gauss lens 22 is 12.2 mm.

Optionally, the radius of curvature of the light incident surface of the third Gauss lens 23 ranges from 800 mm to 1100 mm, the radius of curvature of the light emergent surface of the third Gauss lens 23 ranges from 19.0 mm to 21.0 mm, and the thickness of the third Gauss lens 23 ranges from 3.5 mm to 4.5 mm.

For example, in one embodiment, the radius of curvature of the light incident surface of the third Gauss lens 23 is 987.69 mm, the radius of curvature of the light emergent surface of the third Gauss lens 23 is 20.37 mm, and the thickness of the third Gauss lens 23 is 4.09 mm.

Optionally, the distance between the first Gauss lens 21 and the second Gauss lens 22 is 0.3 mm. Optionally, the distance between the second Gauss lens 22 and the third Gauss lens 23 ranges from 3.7 mm.

In the technical solution shown in FIG. 5, the double-Gauss lens group may consist of seven lenses, where the first three lenses converge the light, and the last four lenses further adjust the light to form scattered, relatively parallel rays. These eight lenses are arranged sequentially from the light incident end to the light emergent end as Gauss lenses 21, 22, 23, 24, 25, and 26.

The parameters of various lenses in the double-Gauss lens group for this embodiment are presented in the following Table 8

TABLE 8

| | Radius of | Radius of | | Distance from |
|---|---|---|---|---|
| | curvature of | curvature of | | the lens on the |
| | light incident | light emergent | Thickness | side of the light |
| | surface | surface | of lens | emergent end |
| | mm | mm | mm | mm |
| Gauss | 40.530 | 2854.905 | 5.598 | 0.300 |
| lens 21 | | | | |
| Gauss | 20.167 | 12.227 | 12.275 | 3.781 |
| lens 22 | | | | |
| Gauss | 987.696 | 20.380 | 4.098 | 4.876 |
| lens 23 | | | | |
| Gauss | −14.806 | −137.285 | 8.205 | 1.416 |
| lens 24 | | | | |
| Gauss | −60.896 | −34.155 | 14.222 | 4.937 |
| lens 25 | | | | |
| Gauss | 150.531 | −71.748 | 7.008 | 13.148 |
| lens 26 | | | | |

Table 8 presents the parameters of the lenses in the double-Gauss lens group of the fisheye lens group “f-theta lens” as shown in FIG. 5. As depicted in FIG. 5, on the side of the light emergent end of Gauss lens 26, it is the other lenses of the second lens group in the detection lens, and the distance from Gauss lens 26 to the next lens along the optical axis is 13.147911 mm. On the side of the light incident end of Gauss lens 21, it is the real image (exit pupil) formed by the first lens group in the detection lens, and the distance from this real image to Gauss lens 21 along the optical axis is 28.558951 mm. In this technical solution, the double-Gauss lens group converges and then diverges the various color rays of the image to compensate for the aberrations of light of different wavelengths, reducing the interference of aberrations on imaging detection.

As shown in FIG. 5, the collimating lens group may consist of six lenses. In this embodiment, the various collimating lenses are arranged sequentially from the light incident end to the light emergent end as collimating lenses 31, 32, 33, 34, 35, and 36. The collimating lens group is used to converge the scattered light processed by the double-Gauss lens group into a regionally parallel beam, and the lights of various colors of different wavelengths converge again into a regionally parallel image, facilitating imaging on the image sensor 4 at the light emergent end.

The parameters of various lenses in the collimating lens group for this embodiment are resented in the following Table 9:

| | Radius of | Radius of | | Distance from |
|---|---|---|---|---|
| | curvature of | curvature of | | the lens on the |
| | light incident | light emergent | Thickness | side of the light |
| | surface | surface | of lens | emergent end |
| | mm | mm | mm | mm |
| Collimating | 32.566 | 469.666 | 8.296 | 25.226 |
| lens 31 | | | | |
| Collimating | −51.1807 | 29.446 | 5.500 | 0.000 |
| lens 32 | | | | |
| Collimating | 29.446 | −35.255 | 6.778 | 0.300 |
| lens 33 | | | | |
| Collimating | −197.442 | −19.447 | 5.937 | 0.000 |
| lens 34 | | | | |
| Collimating | −19.447 | −54.724 | 4.084 | 49.774 |
| lens 35 | | | | |
| Collimating | 80.840 | 323.407 | 7.184 | 67.336 |
| lens 36 | | | | |

Table 9 presents the parameters of the lenses in the collimating lens group of the fisheye lens group “f-theta lens” as shown in FIG. 1. As depicted in FIG. 5, on the side of the light emergent end of the collimating lens 36, it is the image sensor 4, and the distance from the collimating lens 36 to the image sensor 4 along the optical axis is 67.335745 mm. Notably, the light incident and emergent surfaces of the collimating lens 36 are gentle with a large radius of curvature, minimizing aberrations generated after light enters the collimating lens 36. The role of the collimating lens 36 is to correct the direction of the image light, causing it to be irradiated on the image sensor 4 in a form tending to be parallel. On the side of the light incident end of the collimating lens 31, it is the last Gauss lens of the second lens group, that is, Gauss lens 26.

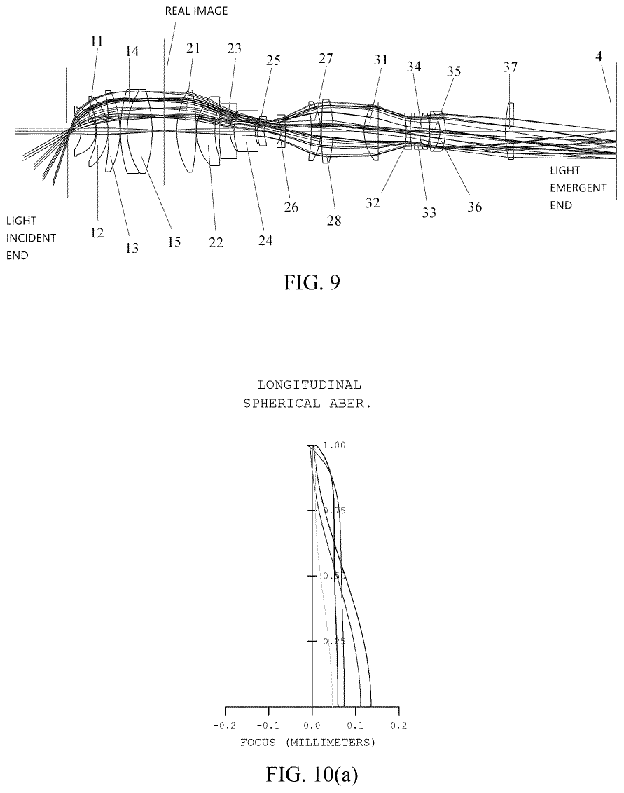

Optionally, in this solution, different glass materials may be used for different lenses to achieve better optical effects. Different glass materials have different refractive indices and astigmatic effects on light of different wavelengths. Glass materials can be selected from existing standard glass materials. Taking the technical solution shown in FIG. 9 as an example, for the first lens group, the glass number of the first condenser lens 11 is 946179, the glass number of the second condenser lens 12 is 806333, the glass number of the third condenser lens 13 is 805255, the glass number of lens 14 is 620603, and the glass number of lens 15 is 593683.

For the double-Gauss lens group, the glass number for Gauss lens 21 is 729547, for Gauss lenses 22 and 23 is 593683, for Gauss lens 24 is 723380, for Gauss lens 25 is 835427, and for Gauss lens 26 is 923209.

For the collimating lens group, the glass number for the collimating lens 31 is 438945, for collimating lens 32 is 805255, for collimating lens 33 is 518590, for collimating lens 34 is 593683, for collimating lens 35 is 806333, and for collimating lens 36 is 805255.

FIG. 6 illustrates the limiting effect of the embodiment shown in FIG. 5 on image aberrations. FIG. 6(a) is a schematic diagram of longitudinal spherical aberration;

FIG. 6(b) is a schematic diagram of field astigmatism; FIG. 6(c) is a schematic diagram of distortion. The distortion in this embodiment is relatively large, with the first and second lens groups forming a fisheye lens group.

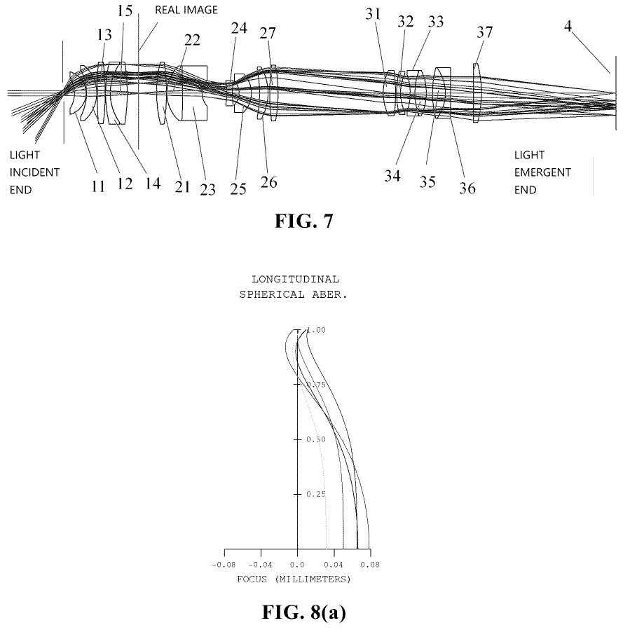

In another specific implementation of this technical solution, FIG. 7 illustrates another implementation using a fisheye lens group.

### Embodiment Four

The following explanation of this solution is based on the embodiment shown in FIG. 7. The field of view angle of the detection lens in this embodiment approaches 120 degrees.

In the scheme shown in FIG. 7, the first lens group may include three condenser lenses, namely the first condenser lens 11, the second condenser lens 12, and the third condenser lens 13. As shown in FIG. 1, the first, second, and third condenser lenses are arranged sequentially from the light incident end to the light emergent end. The first condenser lens 11 is located on the side of the second condenser lens close to the light incident end.

Optionally, in this embodiment, the radius of curvature of the light incident surface of the first condenser lens 11 is −23.07 mm, the radius of curvature of the light emergent surface of the first condenser lens 11 is −17.23 mm, and the thickness of the first condenser lens 11 is 8.90 mm.

The radius of curvature of the light incident surface of the second condenser lens 12 is −38.53 mm, the radius of curvature of the light emergent surface is −28.09 mm. The thickness of the second condenser lens 12 is 7.85 mm; the distance between the first and second condenser lenses is 0.30 mm.

The radius of curvature of the light incident surface of the third condenser lens 13 is 311.91 mm, the radius of curvature of the light emergent surface is −182.47 mm, and the thickness is 6.12 mm. The distance between the second and third condenser lenses is 0.30 mm.

In the aforementioned embodiment of the condenser lenses, the first, second, and third condenser lenses can accurately converge light within a field of view angle of about 120 degrees into the detection lens and process the direction of light irradiation to converge it, causing the light to be irradiated onto subsequent lenses as a whole, which may result in barrel distortion. Further optical processing by subsequent lenses may also result in barrel distortion, eventually forming an image with distortion. The advantage of this embodiment is that fewer condenser lenses can achieve the expected field of view angle, or a larger number of condenser lenses can obtain an extremely large field of view angle. In the edge area of the resulting image, to accommodate more light, a pixel point receives more light compared to the implementation using a flat-field lens. This also causes a relative change in the aberration detection of the edge area of the image.

The first lens group, in addition to including the first, second, and third condenser lenses, may also comprise multiple lenses to enable the formation of an intermediate real image after the light passes through the first lens group.

In this embodiment, the first lens group includes the aforementioned condenser lenses as well as two primary collimating lenses. These two primary collimating lenses are sequentially arranged from the light incident end to the light emergent end as lenses 14 and 15 in the table below.

The parameters of various lenses in the first lens group for this embodiment are presented in the following Table 10:

TABLE 10

| | Radius of | Radius of | | Distance from |
|---|---|---|---|---|
| | curvature of | curvature of | | the lens on the |
| | light incident | light emergent | Thickness | side of the light |
| | surface | surface | of lens | emergent end |
| | mm | mm | mm | mm |
| First | −23.078 | −17.237 | 8.907 | 0.301 |
| condenser | | | | |
| lens 11 | | | | |
| Second | −38.538 | −28.100 | 7.859 | 0.301 |
| condenser | | | | |
| lens 12 | | | | |
| Third | 311.910 | −182.474 | 6.127 | 0.319 |
| condenser | | | | |
| Lens 13 | | | | |
| Lens 14 | 104.377 | 39.483 | 3.521 | 0.000 |
| Lens 15 | 39.483 | −155.826 | 12.962 | 11.422 |

Table 10 presents another implementation of the fisheye lens group “f-theta lens” in this solution, as shown in FIG. 7. Here, on the side of the light emergent end of lens 15, it is the real image presented by the first lens group in the detection lens, and the distance from lens 15 to this real image along the optical axis is 11.421785 mm. On the side of the light incident end of the condenser lens, it is the real image (exit pupil) projected by the head-mounted display, and the distance from this real image to the condenser lens along the optical axis is 8.780251 mm. Specifically, in this technical solution, the light incident end coincides with the real image projected by the head-mounted display, meaning the distance between the light incident end and the condenser lens can also be 8.780251 mm. As shown in FIG. 7, the field of view angle of this optional specific implementation is 120 degrees.

As shown in FIG. 7, the double-Gauss lens group may consist of seven lenses, where the first three lenses converge the light, and the last four lenses further adjust the light to form scattered, relatively parallel rays. These seven lenses are arranged sequentially from the light incident end to the light emergent end as Gauss lenses 21, 22, 23, 24, 25, 26, and 27.

The parameters of various lenses in the double-Gauss lens group for this embodiment are presented in the following Table 11:

TABLE 11

| | Radius of | Radius of | | Distance from |
|---|---|---|---|---|
| | curvature of | curvature of | | the lens on the |
| | light incident | light emergent | Thickness | side of the light |
| | surface | surface | of lens | emergent end |
| | mm | mm | mm | mm |
| Gauss | 100.917 | −165.502 | 7.487 | 0.300 |
| lens 21 | | | | |
| Gauss | 29.100 | −573.405 | 12.000 | 0.000 |
| lens 22 | | | | |
| Gauss | −573.405 | 15.572 | 15.000 | 18.976 |
| lens 23 | | | | |
| Gauss | −42.441 | 79.694 | 4.195 | 5.205 |
| lens 24 | | | | |
| Gauss | −13.089 | −21.710 | 9.300 | 6.257 |
| lens 25 | | | | |
| Gauss | −98.800 | −40.576 | 6.495 | 1.229 |
| lens 26 | | | | |
| Gauss | 163.317 | −120.374 | 6.417 | 80.486 |
| lens 27 | | | | |

Table 11 presents the parameters of the lenses in the double-Gauss lens group of the fisheye lens group “f-theta lens” as shown in the solution of FIG. 7. As depicted in FIG. 7, on the side of the light emergent end of Gauss lens 27, it is the other lenses of the second lens group in the detection lens, and the distance from Gauss lens 27 to the next lens along the optical axis is 80.486371 mm. On the side of the light incident end of Gauss lens 21, it is the real image (exit pupil) formed by the first lens group in the detection lens, and the distance from this real image to Gauss lens 21 along the optical axis is 11.114372 mm. In this technical solution, the double-Gauss lens group converges and then diverges the various color rays of the image to compensate for the aberrations of light of different wavelengths, reducing the interference of aberrations on imaging detection.

As shown in FIG. 11, the collimating lens group may consist of seven lenses. In this embodiment, the various collimating lenses are arranged sequentially from the light incident end to the light emergent end as collimating lenses 31, 32, 33, 34, 35, 36, and 37. The collimating lens group is used to converge the scattered light processed by the double-Gauss lens group into a regionally parallel beam, and the lights of various colors of different wavelengths converge again into a regionally parallel image, facilitating imaging on the image sensor 4 at the light emergent end.

The parameters of various lenses in the double-Gauss lens group for this embodiment are presented in the following Table 12:

TABLE 12

| | Radius of | Radius of | | Distance from |
|---|---|---|---|---|
| | curvature of | curvature of | | the lens on the |
| | light incident | light emergent | Thickness | side of the light |
| | surface | surface | of lens | emergent end |
| | mm | mm | mm | mm |
| Collimating | 40.677 | −139.457 | 9.398 | 0.786 |
| lens 31 | | | | |
| Collimating | 70.332 | 34.331 | 3.002 | 7.400 |
| lens 32 | | | | |
| Collimating | −45.506 | 47.806 | 3.553 | 0.000 |
| lens 33 | | | | |
| Collimating | 47.806 | −41.616 | 8.793 | 4.727 |
| lens 34 | | | | |
| Collimating | 76.760 | −33.003 | 9.818 | 0.000 |
| lens 35 | | | | |
| Collimating | −33.003 | −1109.767 | 4.000 | 17.535 |
| lens 36 | | | | |
| Collimating | 7948.180 | −90.966 | 6.031 | 103.049 |
| lens 37 | | | | |

Table 12 presents the parameters of the lenses in the collimating lens group of the fisheye lens group “f-theta lens” as shown in the solution of FIG. 7. As depicted in FIG. 7, on the side of the light emergent end of the collimating lens 37, it is the image sensor 4, and the distance from the collimating lens 37 to the image sensor 4 along the optical axis is 103.048539 mm. Notably, the light incident surface of the collimating lens 37 tends to be flat, which minimizes the aberration generated after light enters the collimating lens 37, and the collimating lens 37 is used to correct the direction of the image light, causing it to be irradiated on the image sensor 4 in a converging form. On the side of the light incident end of the collimating lens 31, it is the last Gauss lens of the second lens group, that is, Gauss lens 25.

Optionally, in this solution, different glass materials may be used for different lenses to achieve better optical effects. Different glass materials have different refractive indices and astigmatic effects on light of different wavelengths. Glass materials can be selected from existing standard glass materials. Taking the technical solution shown in FIG. 7 as an example, for the first lens group, the glass number of the first condenser lens 11 is 946179, the glass number of the second condenser lens 12 is 835427, the glass number of the third condenser lens 13 and lens 14 is 805255, and the glass number of lens 15 is 620603.

For the double-Gauss lens group, the glass number for Gauss lens 21 is 923209, for Gauss lens 22 is 593683, for Gauss lens 23 is 923209, for Gauss lens 24 is 946179, for Gauss lens 25 is 744449, for Gauss lens 26 is 805255, and for Gauss lens 27 is 806333.

For the collimating lens group, the glass number for the collimating lens 31 is 518590, for collimating lens 32 is 723380, for collimating lens 33 is 805255, for collimating lens 34 is 569713, for collimating lens 35 is 517642, for collimating lens 36 is 806333, and for collimating lens 37 is 805255.

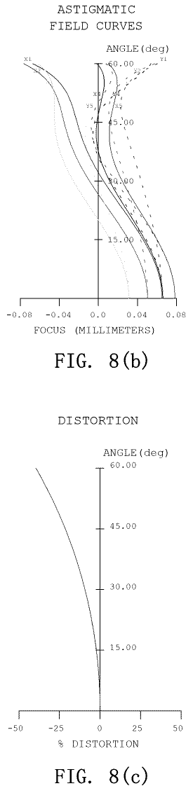

FIG. 8 illustrates the limiting effect of the embodiment shown in FIG. 7 on image aberrations. FIG. 8(a) is a schematic diagram of longitudinal spherical aberration;

FIG. 8(b) is a schematic diagram of field astigmatism; FIG. 8(c) is a schematic diagram of distortion. The distortion in this embodiment is relatively large, with the first lens group and the second lens group forming a fisheye lens group.

In a third aspect, for detection lenses with different longitudinal and lateral field of view angles, these lenses are suitable for detecting head-mounted displays with a wide-screen display effect. For example, the horizontal field of view angle of the detection lens can be 120 degrees, and the vertical field of view angle can be 80 degrees. The first lens group may include two or three condenser lenses, each arranged sequentially from the light incident end to the light emergent end within the first lens group. That is, along the direction from the light incident end to the light emergent end, each condenser lens is located close to the light incident end.

For detection lenses with such field of view characteristics, an implementation of the fisheye lens group “f-theta lens” can be adopted.

Optionally, the effective focal length range of the first lens group can be within 22 mm to 25 mm. This makes it easier for the detection lens to form a larger field of view angle, bringing the field of view angle close to 120 degrees. If the effective focal length of the first lens group is too short, it will collect light over too wide an angle, making it difficult for subsequent lenses to handle field astigmatism, and also affecting the number of lenses in the first and second lens groups and the length along the detection lens direction. If the effective focal length of the first lens group is too long, it will be necessary to adjust the diameter of the first lens group and the detection lens to achieve a suitable field of view angle. Moreover, an overly long focal length makes it difficult for the detection lens to achieve a field of view angle close to 120 degrees. In the implementation where the effective focal length of the first lens group falls within the aforementioned range, when matched with the second lens group having an effective focal length range of 195 mm-285 mm, it can accurately acquire and image the scene within a field of view angle of less than or equal to 120*80 degrees. When the effective focal length range of the second lens group matches that of the first lens group within the aforementioned range, its imaging accuracy is higher, and it can more effectively detect the imaging effect of the head-mounted display.

Optionally, the magnification range of the second lens group can be between 0.6 and 1.0 times. Within this range, the second lens group can more reliably correct aberrations for the real image with a large field of view formed by the first lens group. If the magnification of the second lens group is too high, the size of the aberrations that need to be corrected will also increase, which will increase the difficulty of aberration correction. To correct larger aberrations, the diameter of the second lens group may need to be increased, and the number of lenses it contains may also need to be increased. If the magnification of the second lens group is too small, the adjustments and corrections for the subtle aberrations become more demanding, which raises the precision requirements for the lenses in the second lens group. If the molding accuracy of the lenses in the second lens group is not sufficient, it may not be possible to adjust the subtle aberrations. Therefore, this solution preferably adopts a second lens group with a magnification between 0.7 and 1.3 times to better achieve aberration correction.

Optionally, in a specific embodiment, the effective focal length of the first lens group is 23.4 mm, the effective focal length of the second lens group is 235 mm, and the magnification of the second lens group is 0.72 times. In this embodiment, the detection lens can accurately detect the light images projected by the head-mounted display within a horizontal field of view of 120 degrees and a vertical field of view of 80 degrees, and correct the aberrations generated by its own image capture.

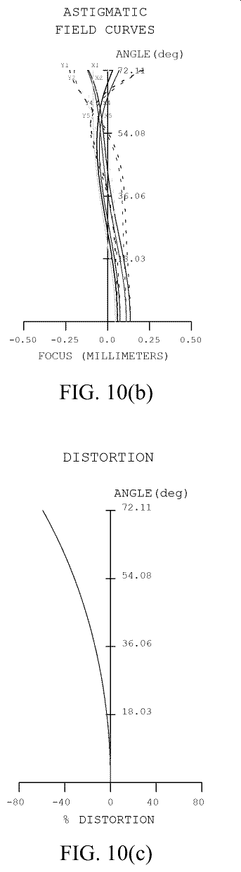

FIG. 10 shows the field aberration diagrams formed by the light of different wavelengths in this embodiment. FIG. 10(a) is a longitudinal spherical aberration diagram, reflecting the effect of the overall lens on the longitudinal spherical aberration of light, with the first and second lens groups of this embodiment limiting spherical aberration to a finite range. FIG. 10(b) is an astigmatism field curve diagram, reflecting the effect of the overall lens on astigmatism of light. The first and second lens groups of this embodiment limit astigmatism to a smaller degree. FIG. 10(c) is a distortion diagram, used to measure the distortion effect of the overall lens on the image. In this embodiment, the first and second lens groups project image light in a form that creates barrel distortion, so as to be able to project the entire field of view angle range of image light onto the image sensor 4.

The different lines in FIG. 10(a) to (c) represent light of different wavelengths.

Optionally, the detection lens includes an image sensor 4, which is set at the light emergent end of the detection lens and is used to receive the light and image processed by the detection lens. The image sensor 4 images the projection from the head-mounted display to analyze the display effect.

In the aforementioned embodiment, the image sensor 4 may optionally have pixels of less than or equal to 4.5 microns, and its color registration can be controlled to be less than or equal to 7.9 microns. An image sensor 4 with pixels of less than or equal to 4.5 microns can usually clearly capture the image of the micro-distance display, facilitating analysis and testing of the display effect. In practical applications, an image sensor 4 with even smaller pixel points can also be used.

Optionally, for the embodiment using the fisheye lens group “f-theta lens,” this technical solution provides two embodiments.

In the first set of implementation schemes, the first lens group may include three condenser lenses, namely the first condenser lens 11, the second condenser lens 12, and the third condenser lens 13. As shown in FIG. 1, the first condenser lens 11, the second condenser lens 12, and the third condenser lens 13 are arranged sequentially from the light incident end to the light emergent end. The first condenser lens 11 is located on the side of the second condenser lens close to the light incident end.

### Embodiment Five

The following explanation of this technical solution is based on the fisheye lens group as shown in FIG. 9. The field of view angle of the detection lens in this embodiment approaches 120*80 degrees.

The first condenser lens 11, the second condenser lens 12, and the third condenser lens 13 converge light within a field of view less than or equal to 120*80 degrees into the detection lens to acquire these lights.

Optionally, the radius of curvature of the light incident surface of the first condenser lens 11 ranges from −20.5 mm to −21.9 mm, the radius of curvature of the light emergent surface of the first condenser lens 11 ranges from −17.7 mm to −18.5 mm, and the thickness range of the first condenser lens 11 is from 10.4 mm to 11.3 mm.

For example, in one embodiment, the radius of curvature of the light incident surface of the first condenser lens 11 is −21.69 mm, the radius of curvature of the light emergent surface of the first condenser lens 11 is −18.24 mm, and the thickness of the first condenser lens 11 is 11.13 mm.

Optionally, the radius of curvature of the light incident surface of the second condenser lens 12 ranges from −50.3 mm to −51.8 mm, the radius of curvature of the light emergent surface of the second condenser lens 12 ranges from −34.1 mm to −34.9 mm, and the thickness range of the second condenser lens 12 is from 8.5 mm to 8.8 mm.

For example, in one embodiment, the radius of curvature of the light incident surface of the second condenser lens 12 is −50.44 mm, the radius of curvature of the light emergent surface of the second condenser lens 12 is −34.70 mm, and the thickness of the second condenser lens 12 is 8.72 mm.

Optionally, the radius of curvature of the light incident surface of the third condenser lens 13 ranges from −160 mm to −300 mm, the radius of curvature of the light emergent surface of the third condenser lens 13 ranges from −60 mm to −80 mm, and the thickness range of the third condenser lens 13 is from 8.0 mm to 8.7 mm.

For example, in one embodiment, the radius of curvature of the light incident surface of the third condenser lens 13 is −171.77 mm, the radius of curvature of the light emergent surface of the third condenser lens 13 is −67.35 mm, and the thickness of the third condenser lens 13 is 8.25 mm.

Optionally, the spacing between the first condenser lens 11 and the second condenser lens 12 is 0.3 mm. Optionally, the spacing between the second condenser lens 12 and the third condenser lens 13 is 0.62 mm.

In the aforementioned embodiment, the three condenser lenses can accurately converge light within a field of view of about 120 degrees*80 degrees into the detection lens and process the direction of light irradiation to be parallel, so that the light is irradiated onto subsequent lenses with minimal aberration. If the radii of curvature of the light incident and emergent surfaces of the first condenser lens 11, the second condenser lens 12, and the third condenser lens 13 differ significantly from the aforementioned ranges, increased aberration may occur after the image light passes through the condenser lenses, thereby increasing the difficulty of subsequent aberration correction. The focal length of the first condenser lens 11 is less than that of the second condenser lens 12, and the focal length of the second condenser lens 12 is less than that of the third condenser lens 13. After the light enters from the light incident end, it gradually propagates towards the direction close to the axis of the detection lens, and the light tends to be parallel. This gentle refractive effect helps to reduce the occurrence of aberrations between different wavelengths of light.

In addition to the first condenser lens 11, the second condenser lens 12, and the third condenser lens 13, the first lens group may also include multiple lenses to form an intermediate real image after the light passes through the first lens group.

In one optional embodiment, the first lens group includes the aforementioned first condenser lens 11, the second condenser lens 12, and the third condenser lens 13, as well as two primary collimating lenses. These two primary collimating lenses are sequentially arranged from the light incident end to the light emergent end as lenses 14 and 15 in the table below.

The parameters of various lenses in the first lens group for this embodiment are presented in the following Table 13:

TABLE 13

| | Radius of | Radius of | | Distance from |
|---|---|---|---|---|
| | curvature of | curvature of | | the lens on the |
| | light incident | light emergent | Thickness | side of the light |
| | surface | surface | of lens | emergent end |
| | mm | mm | mm | mm |
| First | −21.697 | −18.240 | 11.139 | 0.301 |
| condenser | | | | |
| lens 11 | | | | |
| Second | −50.443 | −34.709 | 8.721 | 0.627 |
| condenser | | | | |
| lens 12 | | | | |
| Third | −171.78 | −67.357 | 8.252 | 0.410 |
| condenser | | | | |
| Lens 13 | | | | |
| Lens 14 | 102.564 | 56.526 | 5.000 | 0 |
| Lens 15 | 56.526 | −99.819 | 18.648 | 9.585 |

Table 13 presents an implementation of the fisheye lens group “f-theta lens” in this solution, as shown in FIG. 9. Here, on the side of the light emergent end of lens 15, it is the real image presented by the first lens group in the detection lens, and the distance from lens 15 to this real image along the optical axis is 9.584532 mm. On the side of the light incident end of the first condenser lens 11, it is the real image (exit pupil) projected by the head-mounted display, and the distance from this real image to the first condenser lens 11 along the optical axis is 8.041887 mm. Specifically, in this technical solution, the light incident end coincides with the real image projected by the head-mounted display, meaning the distance between the light incident end and the first condenser lens 11 can also be 8.041887 mm. As shown in FIG. 9, the field of view angle of this optional specific implementation approaches 120 degrees*80 degrees.

As described above, the second lens group is used to compensate for aberrations generated during the overall imaging process, ultimately forming an image on the image sensor 4 located at the light emergent end. Optionally, the second lens group may include a double-Gauss lens group and a collimating lens group.

Optionally, the double-Gauss lens group includes at least three Gauss lenses, which are the first Gauss lens 21, the second Gauss lens 22, and the third Gauss lens 23, arranged sequentially from the light incident end to the light emergent end.

Optionally, the radius of curvature of the light incident surface of the first Gauss lens 21 ranges from 59.5 mm to 62.5 mm, the radius of curvature of the light emergent surface of the first Gauss lens 21 ranges from −165.5 mm to −156.7 mm, and the thickness range of the first Gauss lens 21 is from 14.0 mm to 15.0 mm.

For example, in one embodiment, the radius of curvature of the light incident surface of the first Gauss lens 21 is 60.8 mm, the radius of curvature of the light emergent surface of the first Gauss lens 21 is −164.1 mm, and the thickness of the first Gauss lens 21 is 14.5 mm.

Optionally, the radius of curvature of the light incident surface of the second Gauss lens 22 ranges from 36.0 mm to 39.0 mm, the radius of curvature of the light emergent surface of the second Gauss lens 22 ranges from 60.0 mm to 66.0 mm, and the thickness range of the second Gauss lens 22 is from 13.0 mm to 14.0 mm.

For example, in one embodiment, the radius of curvature of the light incident surface of the second Gauss lens 22 is 37.5 mm, the radius of curvature of the light emergent surface of the second Gauss lens 22 is 61.5 mm, and the thickness of the second Gauss lens 22 is 13.6 mm.

Optionally, the radius of curvature of the light incident surface of the third Gauss lens 23 ranges from 153.0 mm to 156.9 mm, the radius of curvature of the light emergent surface of the third Gauss lens 23 ranges from 23.5 mm to 25.3 mm, and the thickness range of the third Gauss lens 23 is from 7.8 mm to 8.3 mm.

For example, in one embodiment, the radius of curvature of the light incident surface of the third Gauss lens 23 is 154.5 mm, the radius of curvature of the light emergent surface of the third Gauss lens 23 is 24.3 mm, and the thickness of the third Gauss lens 23 is 7.9 mm.

Optionally, the distance between the first Gauss lens 21 and the second Gauss lens 22 is 0.3 mm. Optionally, the distance between the second Gauss lens 22 and the third Gauss lens 23 ranges from 3.0 mm to 3.2 mm. For example, the distance between the second Gauss lens 22 and the third Gauss lens 23 is 3.1 mm.

In the technical solution shown in FIG. 9, the double-Gauss lens group may consist of eight lenses, where the first five lenses converge the light, and the last three lenses further adjust the light to form scattered, relatively parallel rays. These eight lenses are arranged sequentially from the light incident end to the light emergent end as Gauss lenses 21, 22, 23, 24, 25, 26, 27, and 28.

The parameters of various lenses in the double-Gauss lens group for this embodiment are presented in the following Table 14:

TABLE 14

| | Radius of | Radius of | | Distance from |
|---|---|---|---|---|
| | curvature of | curvature of | | the lens on the |
| | light incident | light emergent | Thickness | side of the light |
| | surface | surface | of lens | emergent end |
| | mm | mm | mm | mm |
| Gauss | 60.792 | −164.180 | 14.519 | 0.300 |
| lens 21 | | | | |
| Gauss | 37.569 | 61.583 | 13.617 | 3.171 |
| lens 22 | | | | |
| Gauss | 154.541 | 24.370 | 8.000 | 3.037 |
| lens 23 | | | | |
| Gauss | 39.628 | 26.248 | 15.840 | 1.641 |
| lens 24 | | | | |
| Gauss | 36.167 | 25.090 | 4.944 | 12.516 |
| lens 25 | | | | |
| Gauss | −18.326 | −257.569 | 3.280 | 19.327 |
| lens 26 | | | | |
| Gauss | −112.623 | 44.648 | 7.127 | 0.576 |
| lens 27 | | | | |
| Gauss | 294.441 | −95.929 | 8.497 | 23.181 |
| lens 28 | | | | |

Table 14 presents the parameters of the lenses in the double-Gauss lens group of the fisheye lens group “f-theta lens” as shown in the solution of FIG. 9. As depicted in FIG. 9, on the side of the light emergent end of Gauss lens 28, it is the other lenses of the second lens group in the detection lens, and the distance from Gauss lens 28 to the next lens along the optical axis is 23.180907 mm. On the side of the light incident end of Gauss lens 21, it is the real image (exit pupil) formed by the first lens group in the detection lens, and the distance from this real image to Gauss lens 21 along the optical axis is 8.695056 mm. In this technical solution, the double-Gauss lens group converges and then diverges the various color rays of the image to compensate for the aberrations of light of different wavelengths, reducing the interference of aberrations on imaging detection.

As shown in FIG. 9, the collimating lens group may consist of seven lenses. In this embodiment, the various collimating lenses are arranged sequentially from the light incident end to the light emergent end as collimating lenses 31, 32, 33, 34, 35, 36, and 37. The collimating lens group is used to converge the scattered light processed by the double-Gauss lens group into a regionally parallel beam, and the lights of various colors of different wavelengths converge again into a regionally parallel image, facilitating imaging on the image sensor 4 at the light emergent end.

The parameters of various lenses in the double-Gauss lens group for this embodiment are presented in the following Table 15:

TABLE 15

| | Radius of | Radius of | | Distance from |
|---|---|---|---|---|
| | curvature of | curvature of | | the lens on the |
| | light incident | light emergent | Thickness | side of the light |
| | surface | surface | of lens | emergent end |
| | mm | mm | mm | mm |
| Collimating | 34.947 | −4625.230 | 10.587 | 20.801 |
| lens 31 | | | | |
| Collimating | −70.390 | 59.691 | 3.000 | 3.548 |
| lens 32 | | | | |
| Collimating | −153.217 | 35.708 | 3.500 | 0 |
| lens 33 | | | | |
| Collimating | 35.708 | −63.811 | 7.081 | 0.300 |
| lens 34 | | | | |
| Collimating | 138.494 | −24.009 | 7.634 | 0. |
| lens 35 | | | | |
| Collimating | −24.009 | −44.007 | 4.000 | 44.772 |
| lens 36 | | | | |
| Collimating | 90.374 | 506.973 | 5.787 | 77.036 |
| lens 37 | | | | |

Table 15 presents the parameters of the lenses in the collimating lens group of the fisheye lens group “f-theta lens” as shown in the solution of FIG. 1. As depicted in FIG. 9, on the side of the light emergent end of the collimating lens 37, it is the image sensor 4, and the distance from the collimating lens 37 to the image sensor 4 along the optical axis is 77.035957 mm. Notably, the light incident and emergent surfaces of the collimating lens 37 are gentle with a large radius of curvature, minimizing aberrations generated after light enters the collimating lens 37. The role of the collimating lens 37 is to correct the direction of the image light, causing it to be irradiated on the image sensor 4 in a form tending to be parallel. On the side of the light incident end of the collimating lens 31, it is the last Gauss lens of the second lens group, that is, Gauss lens 28.

Optionally, in this solution, different glass materials may be used for different lenses to achieve better optical effects. Different glass materials have different refractive indices and astigmatic effects on light of different wavelengths. Glass materials can be selected from existing standard glass materials. Taking the technical solution shown in FIG. 9 as an example, for the first lens group, the glass number of the first condenser lens 11 is 946179, the glass number of the second condenser lens 12 is 805255, the glass number of the third condenser lens 13 is 835427, the glass number of lens 14 is 805255, and the glass number of lens 15 is 438945.

For the double-Gauss lens group, the glass number for Gauss lens 21 is 438945, for Gauss lenses 22 and 23 is 805255, for Gauss lens 24 is 717295, for Gauss lens 25 is 946179, for Gauss lens 26 is 518590, for Gauss lens 27 is 805255, and for Gauss lens 28 is 835427.

For the collimating lens group, the glass number for the collimating lens 31 is 438945, for the collimating lens 32 is 923209, for the collimating lens 33 is 805255, for the collimating lens 34 is 438945, for the collimating lens 35 is 593683, for the collimating lens 36 is 805255, and for the collimating lens 37 is 593683.

FIG. 10 illustrates the limiting effect of the embodiment shown in FIG. 9 on image aberrations. FIG. 10(a) is a schematic diagram of longitudinal spherical aberration; FIG. 10(b) is a schematic diagram of field astigmatism; FIG. 10(c) is a schematic diagram of distortion. The distortion in this embodiment is relatively large, with the first lens group and the second lens group forming a fisheye lens group.

Optionally, the first lens group can move along the axial direction within the detection lens, and its axial movement can achieve the focus detection of the detection lens, allowing the image projected by the head-mounted display to be accurately focused and imaged on the image sensor 4.

In a preferred embodiment, the second lens group as a whole can move along the axial direction within the detection lens. The second lens group has a relatively longer overall focal length, and its axial movement can more accurately achieve the focus of the lens, facilitating the precise capture of the image projected by the head-mounted display. This design approach can minimize the imaging error of the detection lens itself, thereby accurately reflecting the imaging effect of the head-mounted display to be detected.

In another specific embodiment of this technical solution, FIG. 11 illustrates another implementation using a fisheye lens group.

### Embodiment Six

Below is the explanation of this solution based on the embodiment shown in FIG. 11. The field of view angle of the detection lens in this embodiment approaches 120 degrees*80 degrees.

In the second set of implementation schemes, the first lens group may include three condenser lenses, namely the first condenser lens 11, the second condenser lens 12, and the third condenser lens 13. As shown in FIG. 1, the first condenser lens 11, the second condenser lens 12, and the third condenser lens 13 are arranged sequentially from the light incident end to the light emergent end. The first condenser lens 11 is located on the side of the second condenser lens close to the light incident end.

Optionally, in this embodiment, the radius of curvature of the light incident surface of the first condenser lens 11 is −20.74 mm, the radius of curvature of the light emergent surface of the first condenser lens 11 is −17.87 mm, and the thickness of the first condenser lens 11 is 10.53 mm;

The radius of curvature of the light incident surface of the second condenser lens 12 is −51.62 mm, the radius of curvature of the light emergent surface of the second condenser lens 12 is −34.26 mm. The thickness of the second condenser lens 12 is 8.65 mm; the distance between the first condenser lens 12 and the second condenser lens is 0.30 mm.

The radius of curvature of the light incident surface of the third condenser lens 13 is −287.14 mm, the radius of curvature of the light emergent surface of the third condenser lens 13 is −74.95 mm, and the thickness of the third condenser lens 13 is 8.51 mm.

In the aforementioned embodiment of the condenser lenses, the first, second, and third condenser lenses can accurately converge light within a horizontal field of view of about 120 degrees and a vertical field of view of about 80 degrees into the detection lens and process the direction of light irradiation to converge it, causing the light to be irradiated onto subsequent lenses as a whole, which may result in barrel distortion. Further optical processing by subsequent lenses may also result in barrel distortion, eventually forming an image with distortion. The advantage of this embodiment is that fewer condenser lenses can achieve the expected field of view angle, or a larger number of condenser lenses can obtain an extremely large field of view angle. In the edge area of the resulting image, to accommodate more light, a pixel point receives more light compared to the implementation using a flat-field lens. This also causes a relative change in the aberration detection of the edge area of the image.

In addition to the first, second, and third condenser lenses, the first lens group may also include multiple lenses to form an intermediate real image after the light passes through the first lens group.

In this embodiment, the first lens group includes the aforementioned condenser lenses as well as two primary collimating lenses, which are sequentially arranged from the light incident end to the light emergent end as lenses 14 and 15 in the table below.

The parameters of various lenses in the first lens group for this embodiment are presented in the following Table 16:

TABLE 16

| | Radius of | Radius of | | Distance from |
|---|---|---|---|---|
| | curvature of | curvature of | | the lens on the |
| | light incident | light emergent | Thickness | side of the light |
| | surface | surface | of lens | emergent end |
| | mm | mm | mm | mm |
| First | −20.746 | −17.875 | 10.531 | 0.300 |
| condenser | | | | |
| lens 11 | | | | |
| Second | −51.627 | −34.264 | 8.650 | 0.300 |
| condenser | | | | |
| lens 12 | | | | |
| Third | −287.149 | −74.951 | 8.514 | 0.300 |
| condenser | | | | |
| Lens 13 | | | | |
| Lens 14 | 123.183 | 59.702 | 5.000 | 0 |
| Lens 15 | 59.702 | −89.138 | 17.459 | 10.372 |

Table 16 presents another implementation of the fisheye lens group “f-theta lens” in this solution, as shown in FIG. 11. Here, on the side of the light emergent end of lens 15, it is the real image presented by the first lens group in the detection lens, and the distance from lens 15 to this real image along the optical axis is 10.372304 mm. On the side of the light incident end of the condenser lens, it is the real image (exit pupil) projected by the head-mounted display, and the distance from this real image to the condenser lens along the optical axis is 8.302543 mm. Specifically, in this technical solution, the light incident end coincides with the real image projected by the head-mounted display, meaning the distance between the light incident end and the condenser lens can also be 8.302543 mm. As shown in FIG. 11, the field of view angle of this optional specific implementation approaches 120 degrees*60 degrees.

As described above, the second lens group is used to compensate for aberrations generated during the overall imaging process, ultimately forming an image on the image sensor 4 located at the light emergent end. The second lens group may include a double-Gauss lens group and a collimating lens group.

As shown in FIG. 11, the double-Gauss lens group may consist of eight lenses, where the first five lenses converge the light, and the last three lenses further adjust the light to form scattered, relatively parallel rays. These eight lenses are arranged sequentially from the light incident end to the light emergent end as Gauss lenses 21, 22, 23, 24, 25, 26, 27, and 28.

The parameters of various lenses in the double-Gauss lens group for this embodiment are presented in the following Table 17:

TABLE 17

| | Radius of | Radius of | | Distance from |
|---|---|---|---|---|
| | curvature of | curvature of | | the lens on the |
| | light incident | light emergent | Thickness | side of the light |
| | surface | surface | of lens | emergent end |
| | mm | mm | mm | mm |
| Gauss | 61.863 | −158.022 | 14.589 | 0.300 |
| lens 21 | | | | |
| Gauss | 37.581 | 64.115 | 13.887 | 3.061 |
| lens 22 | | | | |
| Gauss | 155.527 | 24.167 | 8.000 | 4.490 |
| lens 23 | | | | |
| Gauss | 38.137 | 195.305 | 16.200 | 1.246 |
| lens 24 | | | | |
| Gauss | −11182.667 | 23.465 | 5.000 | 11.527 |
| lens 25 | | | | |
| Gauss | −17.073 | −278.147 | 3.000 | 19.373 |
| lens 26 | | | | |
| Gauss | −104.482 | −41.930 | 6.934 | 0.300 |
| lens 27 | | | | |
| Gauss | 202.162 | −120.092 | 7.153 | 34.865 |
| lens 28 | | | | |

Table 17 presents the parameters of the lenses in the double-Gauss lens group of the fisheye lens group “f-theta lens” as shown in the solution of FIG. 11. As depicted in FIG. 11, on the side of the light emergent end of Gauss lens 28, it is the other lenses of the second lens group in the detection lens, and the distance from Gauss lens 28 to the next lens along the optical axis is 34.865381 mm. On the side of the light incident end of Gauss lens 21, it is the real image (exit pupil) formed by the first lens group in the detection lens, and the distance from this real image to Gauss lens 21 along the optical axis is 17.789416 mm. In this technical solution, the double-Gauss lens group converges and then diverges the various color rays of the image to compensate for the aberrations of light of different wavelengths, reducing the interference of aberrations on imaging detection.

As shown in FIG. 11, the collimating lens group may consist of seven lenses. In this embodiment, the various collimating lenses are arranged sequentially from the light incident end to the light emergent end as collimating lenses 31, 32, 33, 34, 35, 36, and 37. The collimating lens group is used to converge the scattered light processed by the double-Gauss lens group into a regionally parallel beam, and the lights of various colors of different wavelengths converge again into a regionally parallel image, facilitating imaging on the image sensor 4 at the light emergent end.

The parameters of various lenses in the collimating lens group for this embodiment are resented in the following Table 18:

TABLE 18

| | Radius of | Radius of | | Distance from |
|---|---|---|---|---|
| | curvature of | curvature of | | the lens on the |
| | light incident | light emergent | Thickness | side of the light |
| | surface | surface | of lens | emergent end |
| | mm | mm | mm | mm |
| Collimating | 33.703 | −1483.014 | 11.352 | 21.297 |
| lens 31 | | | | |
| Collimating | −49.991 | 53.670 | 3.000 | 3.757 |
| lens 32 | | | | |
| Collimating | −207.948 | 43.715 | 3.500 | 0.000 |
| lens 33 | | | | |
| Collimating | 43.715 | −48.838 | 9.809 | 3.223 |
| lens 34 | | | | |
| Collimating | 89.475 | −27.828 | 11.845 | 0.000 |
| lens 35 | | | | |
| Collimating | −27.828 | −62.307 | 8.000 | 10.146 |
| lens 36 | | | | |
| Collimating | 95.173 | −197.752 | 6.627 | 68.942 |
| lens 37 | | | | |

Table 18 presents the parameters of the lenses in the collimating lens group of the fisheye lens group “f-theta lens” as shown in the solution of FIG. 11. As depicted in FIG. 11, on the side of the light emergent end of the collimating lens 37, it is the image sensor 4, and the distance from the collimating lens 37 to the image sensor 4 along the optical axis is 68.942486 mm. Notably, the light emergent surface of the collimating lens 37 tends to be flat, which minimizes the aberration generated after the light exits the collimating lens 37. The role of the collimating lens 37 is to correct the direction of the image light, causing it to be irradiated on the image sensor 4 in a converging form. On the side of the light incident end of the collimating lens 31, it is the last Gauss lens of the second lens group, that is, Gauss lens 25.

Optionally, in this solution, different glass materials may be used for different lenses to achieve better optical effects. Different glass materials have different refractive indices and astigmatic effects on light of different wavelengths. Glass materials can be selected from existing standard glass materials. Taking the technical solution shown in FIG. 11 as an example, for the first lens group, the glass number of the first condenser lens 11 is 946179, the glass number of the second condenser lens 12 is 805255, the glass number of the third condenser lens 13 is 835427, the glass number of lens 14 is 805255, and the glass number of lens 15 is 438945.

For the double-Gauss lens group, the glass number for Gauss lens 21 is 438945, for Gauss lenses 22 and 23 is 805255, for Gauss lens 24 is 717295, for Gauss lens 25 is 946179, for Gauss lens 26 is 518590, for Gauss lens 27 is 805255, and for Gauss lens 28 is 835427.

For the collimating lens group, the glass number for the collimating lens 31 is 438945, for the collimating lens 32 is 923209, for the collimating lens 33 is 805255, for the collimating lens 34 is 438945, for the collimating lens 35 is 593683, for the collimating lens 36 is 805255, and for the collimating lens 37 is 593683.

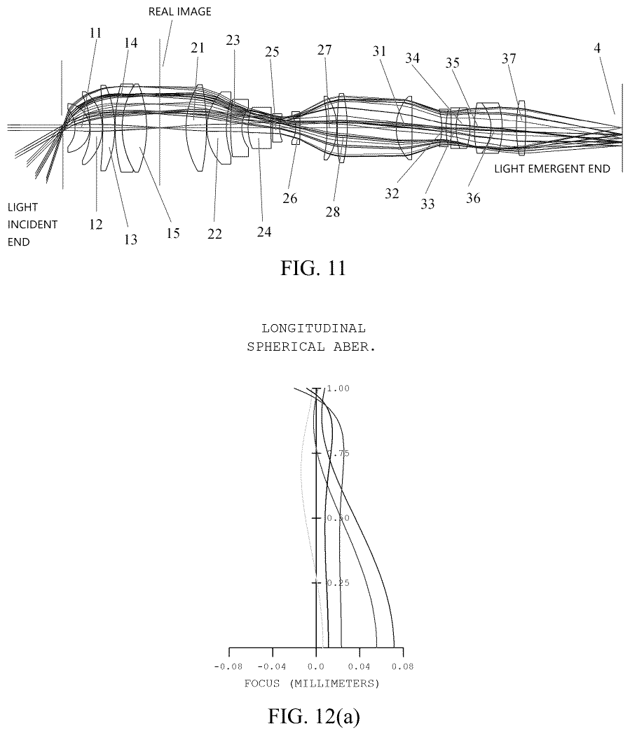

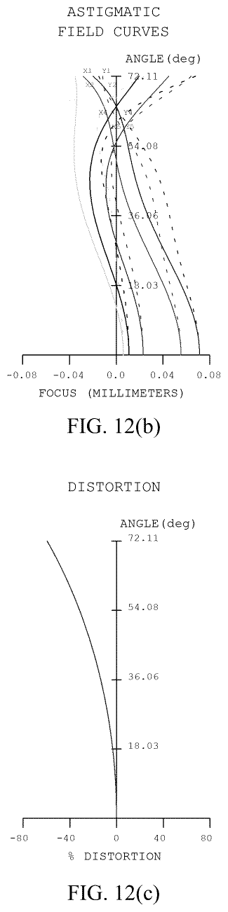

FIG. 12 illustrates the limiting effect of the embodiment shown in FIG. 11 on image aberration. FIG. 12(a) is a schematic diagram of longitudinal spherical aberration;

FIG. 12(b) is a schematic diagram of field astigmatism; FIG. 12(c) is a schematic diagram of distortion. The distortion in this embodiment is relatively large, with the first lens group and the second lens group forming a fisheye lens group.

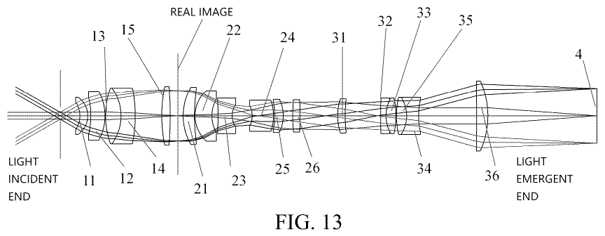

In another specific implementation of this technical solution, a flat-field lens group “f-tan(theta) lens” can be used. FIG. 13 shows the structural layout of each lens in this implementation, and the following explanation of this technical solution is based on the flat-field lens group as shown in FIG. 13.

In this technical solution, the first lens group includes a first condenser lens 11 and a second condenser lens 12. The two condenser lenses can accurately gather light within a field of view of about 60 degrees into the barrel and parallelize the direction of light irradiation, allowing the light to be irradiated onto subsequent lenses with minimal aberration.

The first lens group also includes three primary collimating lenses, which are sequentially arranged from the light incident end to the light emergent end as lenses 13, 14, and 15 in the table below.

The parameters of various lenses in the first lens group for this embodiment are presented in the following Table 19:

TABLE 19

| | Radius of | Radius of | | Distance from |
|---|---|---|---|---|
| | curvature of | curvature of | | the lens on the |
| | light incident | light emergent | Thickness | side of the light |
| | surface | surface | of lens | emergent end |
| | mm | mm | mm | mm |
| First | −14.043 | −12.915 | 4.46 | 1.694 |
| condenser | | | | |
| lens 11 | | | | |
| Second | −46.248 | −29.45 | 8.0 | 0.3 |
| condenser | | | | |
| lens 12 | | | | |
| Third | 47.059 | −27.016 | 8.7 | 0 |
| condenser | | | | |
| Lens 13 | | | | |
| Lens 14 | −27.016 | −80.387 | 8.0 | 14.907 |
| Lens 15 | 83.116 | −218.487 | 4.72 | 3.45 |

Table 19 presents an implementation of a flat-field lens group “f-tan(theta) lens” in this solution, as shown in FIG. 13. Here, on the side of the light emergent end of lens 15, it is the real image presented by the first lens group within the barrel, and the distance from lens 15 to this real image along the optical axis is 3.450000 mm. On the side of the light incident end of the first condenser lens 11, it is the real image projected by the head-mounted display, and the distance from this real image to the first condenser lens 11 along the optical axis is 10.985000 mm. Specifically, in this technical solution, the light incident end coincides with the real image projected by the head-mounted display, meaning the distance between the real image and the first condenser lens 11 can also be 10.985000 mm. As shown in FIG. 13, the field of view angle of this optional specific implementation approaches 60 degrees.

As described above, the second lens group is used to compensate for aberrations generated during the overall imaging process, ultimately forming an image on the image sensor 4 located at the light emergent end. Optionally, the second lens group may include a double-Gauss lens group and a collimating lens group.

As shown in FIG. 13, the double-Gauss lens group may consist of six lenses, where the first three lenses converge the light, and the last three lenses further adjust the light to form scattered, relatively parallel rays. These six lenses are arranged sequentially from the light incident end to the light emergent end as Gauss lenses 21, 22, 23, 24, 25, and 26.

The parameters of various lenses in the double-Gauss lens group for this embodiment are presented in the following Table 20:

TABLE 20

| | Radius of | Radius of | | Distance from |
|---|---|---|---|---|
| | curvature of | curvature of | | the lens on the |
| | light incident | light emergent | Thickness | side of the light |
| | surface | surface | of lens | emergent end |
| | mm | mm | mm | mm |
| Gauss | 32.453 | 108.881 | 6.38 | 0.3 |
| lens 21 | | | | |
| Gauss | 19.292 | 18.895 | 9.47 | 3.41 |
| lens 22 | | | | |
| Gauss | −230.126 | 10.963 | 8.0 | 11.25 |
| lens 23 | | | | |
| Gauss | −12.253 | −26.799 | 12.0 | 0.657 |
| lens 24 | | | | |
| Gauss | −41.033 | −21.55 | 4.83 | 5.35 |
| lens 25 | | | | |
| Gauss | 120.539 | −327.587 | 4.0 | 21.22 |
| lens 26 | | | | |

Table 20 presents the parameters of the lenses in the double-Gauss lens group of the flat-field lens group “f-tan(theta) lens” as shown in the solution of FIG. 13. As depicted in FIG. 13, on the side of the light emergent end of Gauss lens 26, it is the other lenses of the second lens group within the barrel, and the distance from Gauss lens 26 to the next lens along the optical axis is 21.220000 mm. On the side of the light incident end of Gauss lens 21, it is the real image (exit pupil) formed by the first lens group within the barrel, and the distance from this real image to Gauss lens 21 along the optical axis is 3.450000 mm. In this technical solution, the double-Gauss lens group converges and then diverges the various color rays of the image to compensate for the aberrations of light of different wavelengths, reducing the interference of aberrations on imaging detection.

As shown in FIG. 13, the collimating lens group may consist of six lenses. In this embodiment, the various collimating lenses are arranged sequentially from the light incident end to the light emergent end as collimating lenses 31, 32, 33, 34, 35, and 36. The collimating lens group is used to converge the scattered light processed by the double-Gauss lens group into a regionally parallel beam, and the lights of various colors of different wavelengths converge again into a regionally parallel image, facilitating imaging on the image sensor 4 at the light emergent end.

The parameters of various lenses in the collimating lens group for this embodiment are resented in the following Table 21:

TABLE 21

| | Radius of | Radius of | | Distance from |
|---|---|---|---|---|
| | curvature of | curvature of | | the lens on the |
| | light incident | light emergent | Thickness | side of the light |
| | surface | surface | of lens | emergent end |
| | mm | mm | mm | mm |
| Collimating | 30.276 | 78.297 | 4.22 | 19.996 |
| lens 31 | | | | |
| Collimating | 451.212 | 20.167 | 3.0 | 0 |
| lens 32 | | | | |
| Collimating | 20.167 | −47.61 | 5.54 | 0.3 |
| lens 33 | | | | |
| Collimating | 45.556 | −19.516 | 5.76 | 0 |
| lens 34 | | | | |
| Collimating | −19.516 | 41.462 | 6.7 | 32.583 |
| lens 35 | | | | |
| Collimating | −1389.438 | −48.812 | 6.35 | 61.34 |
| lens 36 | | | | |

Table 21 presents the parameters of the lenses in the collimating lens group of the flat-field lens group “f-tan(theta) lens” as shown in the solution of FIG. 13. As depicted in FIG. 13, on the side of the light emergent end of the collimating lens 36, it is the image sensor 4, and the distance from the collimating lens 36 to the image sensor 4 along the optical axis is 61.340000 mm. Notably, the light incident surface of the collimating lens 36 tends to be flat, which minimizes the aberration generated after the light enters the collimating lens 36. The role of the collimating lens 36 is to correct the direction of the image light, causing it to be irradiated on the image sensor 4 in a form tending to be parallel. On the side of the light incident end of the collimating lens 31, it is the last Gauss lens of the second lens group, that is, Gauss lens 26.

Optionally, in this solution, different glass materials may be used for different lenses to achieve better optical effects. Different glass materials have different refractive indices and astigmatic effects on light of different wavelengths. Glass materials can be selected from existing standard glass materials. Taking the technical solution shown in FIG. 1 as an example, for the first lens group, the glass number of the first condenser lens 11 is 805255, the glass number of the second condenser lens 12 is 805255, the glass number of lens 13 is 518590, the glass number of lens 14 is 805255, and the glass number of lens 15 is 518590.

For the double-Gauss lens group, the glass number for Gauss lens 21 and Gauss lens 22 is 835427, the glass number for Gauss lens 23 is 593683, the glass number for Gauss lens 24 is 835427, the glass number for Gauss lens 25 is 729547, and the glass number for Gauss lens 26 is 805255.

For the collimating lens group, the glass number for the collimating lens 31 is 593683, the glass number for the collimating lens 32 is 850300, the glass numbers for the collimating lenses 33 and 34 are 593683, the glass number for the collimating lens 35 is 850301, and the glass number for the collimating lens 36 is 805255.

The present technical solution also provides a detection method for a head-mounted display, which includes using the detection lens in the aforementioned solution, aligning a light incident end of the detection lens with the display area of the head-mounted display to be detected. Preferably, the axis of the detection lens overlaps with the display optical axis of the head-mounted display to be detected.

Adjust the light incident end of the detection lens in its axial direction to a position where it overlaps with the real image projected by the head-mounted display to be detected.

Acquire the image projected by the head-mounted display to be detected using the aforementioned detection lens. Subsequently, analyze the acquired images.

The above disclosure is merely an example of a preferred embodiment of the present disclosure, and of course, should not be used to limit the scope of the present disclosure. Those of ordinary skill in the art can understand how to implement all or part of the procedures of the above embodiment, and equivalent variations made in accordance with the claims of the present disclosure are still within the scope of the invention.

1. A detection lens for a head-mounted display, wherein,
the detection lens has a light incident end and is configured to receive light from the light incident end;
the detection lens comprises a lens group, wherein and an overall entrance pupil of the lens group overlaps with an aperture stop of the lens group; and
the lens group comprises a first lens group and a second lens group, wherein
the first lens group is closer to the light incident end relative to the second lens group in an axial direction of the detection lens,
an effective focal length of the first lens group ranges from 15 mm to 40 mm,
a magnification of the second lens group ranges from 0.5 to 2, and
an effective focal length of the second lens group ranges from 40 mm to 500 mm.

2. The detection lens according to claim 1, wherein, an aperture stop of the detection lens is less than or equal to 5 mm.

3. The detection lens according to claim 1, wherein, both the first lens group and the second lens group have a diameter of less than or equal to 65 mm.

4. The detection lens according to claim 1, wherein,
the first lens group comprises at least one condenser lens with a positive optical power; and
the second lens group comprises a double-Gauss lens group.

5. The detection lens according to claim 4, wherein, the detection lens has a field-of-view angle ranging from 55 degrees to 125 degrees.

6. The detection lens according to claim 5, wherein,
the field-of-view angle of the detection lens ranges from 55 degrees to 70 degrees; and
the first lens group comprises one or two condenser lenses, wherein, in the axial direction of the detection lens, each of the condenser lenses is located close to the light incident end in the first lens group.

7. The detection lens according to claim 6, wherein,
the first lens group comprises two condenser lenses which are respectively a first condenser lens and a second condenser lens, with the first condenser lens being closer to the light incident end relative to the second condenser lens;
a radius of curvature of the light incident surface of the first condenser lens ranges from −14.5 mm to −16.5 mm, a radius of curvature of the light emergent surface of the first condenser lens ranges from −12.5 mm to −14.5 mm, and a thickness of the first condenser lens ranges from 2.7 mm to 3.9 mm; and
a radius of curvature of the light incident surface of the second condenser lens ranges from −55.0 mm to −64.0 mm, a radius of curvature of the light emergent surface of the second condenser lens ranges from −27.0 mm to −33.5 mm, and a thickness of the second condenser lens ranges from 4.5 mm to 6.5 mm.

8. The detection lens according to claim 5, wherein,
the field-of-view angle of the detection lens ranges from 70 degrees to 125 degrees; and
the first lens group comprise two or three condenser lenses, wherein, in the axial direction of the detection lens, each of the condenser lenses is located close to the light incident end in the first lens group.

9. The detection lens according to claim 8, wherein,
the first lens group comprises two condenser lenses which are respectively a first condenser lens and a second condenser lens, with the first condenser lens being close to the light incident end relative to the second condenser lens;
a radius of curvature of the light incident surface of the first condenser lens ranges from −9.2 mm to −12.0 mm, a radius of curvature of the light emergent surface of the first condenser lens ranges from −10.4 mm to −12.1 mm, and a thickness of the first condenser lens ranges from 6.5 mm to 8.4 mm;
a radius of curvature of the light incident surface of the second condenser lens ranges from −140.0 mm to −152.0 mm, a radius of curvature of the light emergent surface of the second condenser lens ranges from −27.0 mm to −33.5 mm, and a thickness of the second condenser lens ranges from 4.2 mm to 5.1 mm; and
the field-of-view angle of the detection lens ranges from 70 degrees to 95 degrees.

10. A detection method for a head-mounted display, comprising:
using the detection lens according to claim 1;
aligning a light incident end of the detection lens with a head-mounted display to be detected, so that the axis of the lens overlaps with the optical axis of the device to be detected;
adjusting the light incident end of the detection lens in its axial direction to a position where it overlaps with the exit pupil projected by the head-mounted display to be detected; and
acquiring the image projected by the head-mounted display to be detected using the detection lens.
